(19) United States
(12) Patent Application Publication
(10) Pub. No.: US 2007/0027947 A1
(43) Pub. Date: Feb. 1, 2007

(54) Approval administration system and method thereof

(75) Inventor: Hideo Yokoyama, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/070,008

(22) Filed: Mar. 3, 2005

(30) Foreign Application Priority Data
Mar. 4, 2004 (JP) 2004-060020
Feb. 28, 2005 (JP) 2005-052464

(51) Int. Cl. G06F 15/16

(52) U.S. Cl. 709/203

(57) ABSTRACT

A simple approval administration system and a method which can reliably administrate information regarding proposal and approval are provided. A proposer terminal sends proposal data to a host server, which stores the proposal data on a proposal DB 110 by correlating the proposal data with an administration ID and sends permission to print a proposal form to the proposer terminal. The proposer terminal 200 prints the proposal form (paper document). After confirming the content of the proposal form, a user of an approver terminal 300 approves the content of the proposal form and then sends approval information to the host server 100. The host server 100 stores the proposal data (on which the approved information is stored) on the master DB by correlating the proposal data with the administration ID and sends permission to print the approved proposal form to the approver terminal, which prints the approved proposal form (paper document).

### CROSS-REFERENCE TO RELATED APPLICATIONS

The present application claims the benefit of patent application number 2004-060020, filed in Japan on Mar. 4, 2004, and the subject matter of which is hereby incorporated herein by reference.

### BACKGROUND OF THE INVENTION

1. Field of the Invention

The present invention relates to an approval administration system and a method thereof, and more specifically, it relates to a simple system which can reliably administrate information regarding proposal and approval.

2. Description of the Related Art

In an organization such as a company or the like, in general, an approver approves proposal items by a proposer to reliably administrate the content for decision of the organization. As an example of the proposal items, a unit price of a product to be delivered, a request for payment, a plan for production, a plan for sale, or the like may be included.

When a plurality of proposal items by the proposer are present, or when a plurality of proposers exist, or when the proposal items are corrected, or the like, there is a problem in that proposal and approval processes will take much time, and thus work efficiency is degraded.

In order to make efficient proposal and approval processes possible, in recent years, an electronic approval system using a computer has been utilized. For example, Patent Document 1 (Japanese Unexamined Patent Application Publication No. 2002-73937) describes a technique in which an employee proposes and approves business expenses with a personal computer terminal which is connected to an intranet. More specifically, a technique in which the proposer sets advanced proposal and advanced approval steps by inputting advanced proposal data of business expenses and correlates the post accurate account data at post accurate account steps with advanced proposal data may be included. According to this technique, instead of unconditionally approving of the business expenses, with the advanced approval step, it is possible to administrate such that the business expenses are effectively estimated.

However, in the configuration of the above-described prior art, an extensive system regarding electronic approval is required, which results in a problem in that the system is hard to administrate.

### SUMMARY OF THE INVENTION

It is an object of the present invention, as one feature, to provide a simple approval administration system and a method which can reliably administrate information regarding proposal and approval. The present invention includes the following features.

(1) A networked computer system in accordance with the present invention includes (a) an online-network which is accessible to multiple users; (b) a server device connected to the online-network for storing a database comprising proposal data proposed by a first user and needs to be approved by a second user; (c) a first computer operated by the first user for inputting the proposal data and storing it in the database on the server device through the online-network; and (d) a second computer operated by the second user for accessing the proposal data on the server device, adding approval information with respect to the proposal data, and storing it in the database on the server device through the online-network; wherein the computer system further comprising: (e) a storage medium which is independent of the online-network to be used for writing proposal data on the medium in accordance with the server device direction when the proposal data is stored on the database at the time of inputting the proposal data by the first user, wherein the medium can be transferable from the first user to the second user for approval session subsequent to the proposal data inputting session, and is used for writing approval information on the medium in accordance with the server device direction when the approval information is added in the database at the time of inputting the approval information by the second user, as well as for writing an identification information, which can be used for correlating the proposal data and/or the approval information in the medium with the proposal data and/or the approval data in the database, on the medium.

(2) An approval administration system in accordance with the present invention includes (a) means for obtaining proposal data sent from a terminal device operated by a proposer; (b) means for generating an administration ID which can be used for uniquely identify proposal data in the system when the proposal data obtaining means obtains the proposal data; (c) means for storing the proposal data on a proposal data storing unit in correlating the proposal data with the administration ID; (d) means for outputting permission to print a proposal form with the administration ID based on the proposal data stored by the proposal data storing means; (e) means for obtaining approval information sent from a terminal device operated by an approver who approves the proposal form; (f) means for adding approval information to the proposal data when the approval information obtaining means obtains the approval information; (g) means for storing proposal data, which is stored by the proposal data storing means, on an approved proposal data storing unit only if the adding means adds approval information to the stored proposal data; and (h) means for outputting permission to print an approved proposal form with the administration ID based on the approved proposal data only when the approved proposal data storing means stores the proposal data.

(3) An approval administration system in accordance with the present invention includes (a) means for obtaining proposal data sent from a terminal device operated by a proposer; (b) means for generating an administration ID which can be used for uniquely identify proposal data in the system when the proposal data obtaining means obtains the proposal data; (c) means for storing the proposal data on a proposal data storing unit in correlating the proposal data with the administration ID; (d) means for outputting permission to store proposal information with the administration ID on a storage medium which is independently transportable from the online-network based on the proposal data stored by the proposal data storing means; (e) means for obtaining approval information sent from a terminal device operated by an approver who approves the proposal information; (f) means for adding approval information to the proposal data when the approval information obtaining means obtains the approval information; (g) means for storing proposal data, which is stored by the proposal data storing means, on an approved proposal data storing unit only if the adding means adds approval information to the stored proposal data; and (h) means for outputting permission to store approved proposal information with the administration ID on the medium based on the approved proposal data only when the approved proposal data storing means stores the proposal data.

(6) The approval administration system in accordance with the present invention, wherein the proposal form and the approved proposal form are attachable to each other.

(7) The approval administration system in accordance with the present invention, wherein (b) the ID generating means further generates a new administration ID, which is distinct from the administration ID, with respect to the proposal data stored by the proposal data storing means when obtaining a correction request and corrected proposal data sent from the proposer terminal device; (c) the proposal data storing means stores the corrected proposal data on the proposal data storing unit in correlating the corrected proposal data with the new administration ID; and (d) the print permission outputting means outputs permission to print a proposal form with the new administration ID based on the proposal data stored by (c) the proposal data storing means.

The followings are definitions of the terms.

In the present invention, the “proposal form” is the concept including a general concept that a proposal item to be approved is displayed. As the proposal item, for example, the registration of a unit price of a product (the fixing of the unit price, the change of the unit price or the like), the request for purchase (the supplier, the time limit for delivery, the product number, the quantity, the deliverer, or the like), the request for production (the producer, the product number, the time limit for delivery, the quantity, or the like), the correction of information, or the like may be included. Moreover, as the proposal form, mediums such as a printed paper document, a slip, or paper for facsimile, plastic on which a predetermined item can be displayed, or the like may be included. In the embodiments, a proposal list shown in FIG. 12 corresponds to the concept of the “proposal form”.

The “approved proposal form” is the concept including a general concept that the approved proposal item is displayed. As the approved proposal item to be displayed, for example, a proposal item with an approval notice added thereto, a proposal item with a registration notice added thereto, a proposal item with a confirmation notice added thereto, a proposal item with a storage notice in a predetermined storage location added thereto, a proposal item with a storage notice on a predetermined storage medium added thereto, a proposal item with an uncorrectable notice added thereto, or the like may be included. Moreover, as the approved proposal form, mediums such as a printed paper document, a slip, paper for facsimile, plastic on which a predetermined item can be displayed, or the like may be included. In the embodiments, a master update list shown in FIG. 15 corresponds to the concept of the “approved proposal form”.

The features of the present invention can be described broadly as set forth above. The structures and characteristics of the present invention will be apparent from the following detailed description of the invention together with those features, effects, and drawings.

### BRIEF DESCRIPTION OF THE DRAWINGS

FIG. 1 illustrates an overall diagram showing an external medium-type electronic approval system according to an embodiment.

FIG. 2 illustrates a diagram showing a process summary of the external medium-type electronic approval system according to a first embodiment.

FIG. 3 illustrates a functional block diagram of a host server included in the external medium-type electronic approval system.

FIG. 4 illustrates an example of a hardware configuration of a host server of an embodiment.

FIG. 5 illustrates an example of a hardware configuration of a proposer terminal device of an embodiment.

FIG. 6 illustrates an example of a hardware configuration of an approver terminal device of an embodiment.

FIG. 7 illustrates an example of a configuration of a proposal database of an embodiment.

FIG. 8 illustrates an example of a configuration of a master database of an embodiment.

FIG. 9 illustrates an example of a configuration of an administration number database of an embodiment.

FIG. 10 illustrates a flowchart of a proposal information registration processing program of an embodiment.

FIGS. 11A and 11B illustrate examples of a screen display of the proposer terminal device in a proposal information registration process.

FIG. 12 illustrates an example of a proposal form outputted in the proposal information registration process.

FIG. 13 illustrates a flowchart of an approval processing program of an embodiment.

FIG. 14 illustrates an example of a screen display of the approver terminal device during an approval process.

FIG. 15 illustrates an example of a master update list outputted during the approval process.

FIGS. 16A and 16B illustrate examples of the configurations of the proposal database and the master database during the approval process.

FIG. 17 illustrates a flowchart of a reproposal information registration processing program of an embodiment.

FIGS. 18A to 18C illustrate examples of a screen display of the proposer terminal device in a reproposal information registration process.

FIG. 19 illustrates an example of a configuration of a proposal database according to a second embodiment.

FIG. 20 illustrates a flowchart of an approval processing system according to the second embodiment.

FIG. 21 is a diagram showing a process summary of an external medium-type electronic approval system according to a third embodiment.

FIG. 22 illustrates a flowchart of a proposal information registration processing program according to the third embodiment.

FIG. 23 illustrates a flowchart of an approval processing program according to the third embodiment.

FIG. 24A is a schematic diagram showing the relationship among “a proposal list”, “a master update list”, and “a master DB” according to the first embodiment, and FIG. 24B is a schematic diagram showing the relationship between “a memory card (master updated)” and “a master DB” according to the third embodiment.

### DESCRIPTION OF THE PREFERRED EMBODIMENTS

An “external medium-type electronic approval system (or “external medium combined use-type electronic approval system)” as an embodiment of the present invention will be explained. The external medium-type electronic approval system is a system which can reliably administrate proposal information and approval information with respect to the proposal.

Here, in general, proposal information which is administrated by the “external medium-type electronic approval system” corresponds to general information on proposal, request, or the like whose content is decided or confirmed by obtaining approval or consent. As an example of proposal information, the registration of the unit price of the product (the fixing of the unit price, the change of the unit price, or the like), the request for purchase (the supplier, the time limit for delivery, the product number, the quantity, the deliverer, or the like), the request for production (the producer, the product number, the time limit for delivery, the quantity, or the like), the correction of information, or the like may be included.

The “external medium-type electronic approval system” described below can be carried out for general proposal information including the above-described items, but the embodiments described below will be explained for “the unit price registration (the fixing of the unit price)” of the product as an example.

Hereinafter, the outline of the external medium-type electronic approval system, and the hardware configuration of the device will be explained with regard to the correspondence of the terminology and embodiments described in the claims, and then the embodiments will be explained.

Contents

1. Summary of External Medium-type Electronic Approval System

2. Hardware Configuration etc.

3. Function of Device

4. First Embodiment

5. Second Embodiment

6. Third Embodiment

7. Effects of Embodiments

8. Other Embodiments

### 1. Summary of External Medium-Type Electronic Approval System

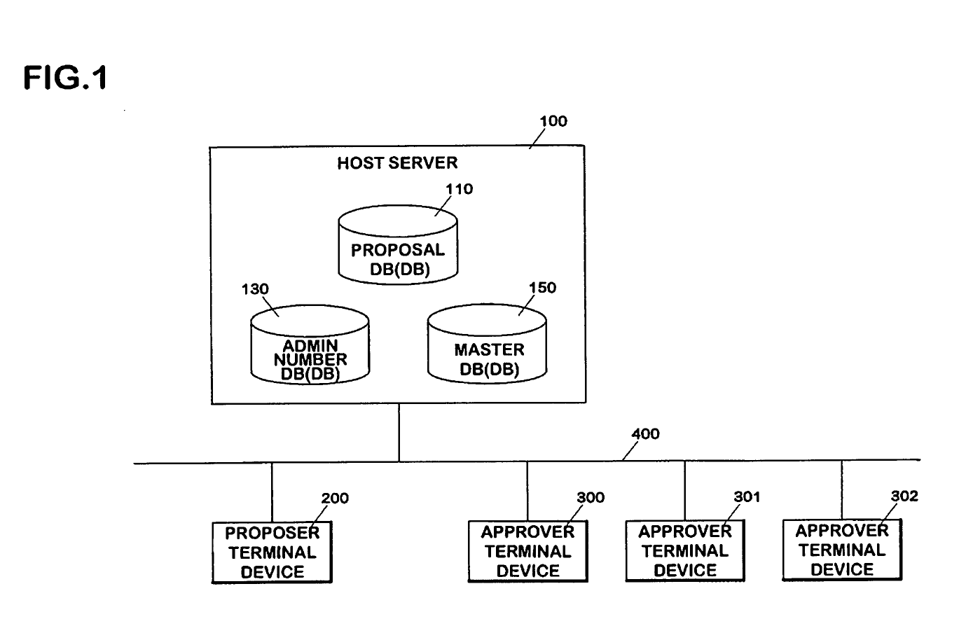

FIG. 1 illustrates a summary of an external medium-type electronic approval system according to an embodiment. The external medium-type electronic approval system has a host server 100 serving as an “approval administration system”, and a proposer terminal device 200, an approver terminal device 300, an approver terminal device 301, and an approver terminal device 302 which are connected to the host server 100 via a Local Area Network (LAN) 400. Moreover, the connection of the host server 100 and the proposer terminal device 200 or the approver terminal device 300 (or the approver terminals 301 and 302; the same is applied to the following) is not limited to the LAN 400, but an intranet, a leased line, a telephone line, or the like may be adopted. In the embodiment, as an example, the host server 100, the proposer terminal device 200, and the approver terminal device 300 are used by persons who belong to the same organization (for example, the same company).

However, the present invention is not limited to this configuration. For example, the host server 100, the proposer terminal device 200, the approver terminal device 300 may be used by persons who belong to a plurality of organizations. Further, in the embodiment, for convenience of explanation, a system provided with one proposer terminal device 200 and one approver terminal device 300 is exemplified. However, a system provided with a plurality of terminals is also executable similarly to the embodiment.

The proposer terminal device 200 is administrated by a user who fixes a unit price of a product and proposes a fixed unit price. On the other hand, the approver terminal device 300 is administrated by a user who examines the content of the proposal and judges whether or not the proposal is to be approved. The host server 100 executes a process that administrates information regarding the proposal and the approval.

The host server 100 stores a proposal database (hereinafter, referred to as “DB”) 110, an administration number DB 130, and a master DB 150. The stored contents of the respective DBs will be described later. The respective DBs are stored in a hard disk (or a memory) of the host server 100, but the present invention is not limited to this configuration. The DBs may be stored in devices which are physically independent of the host server 100.

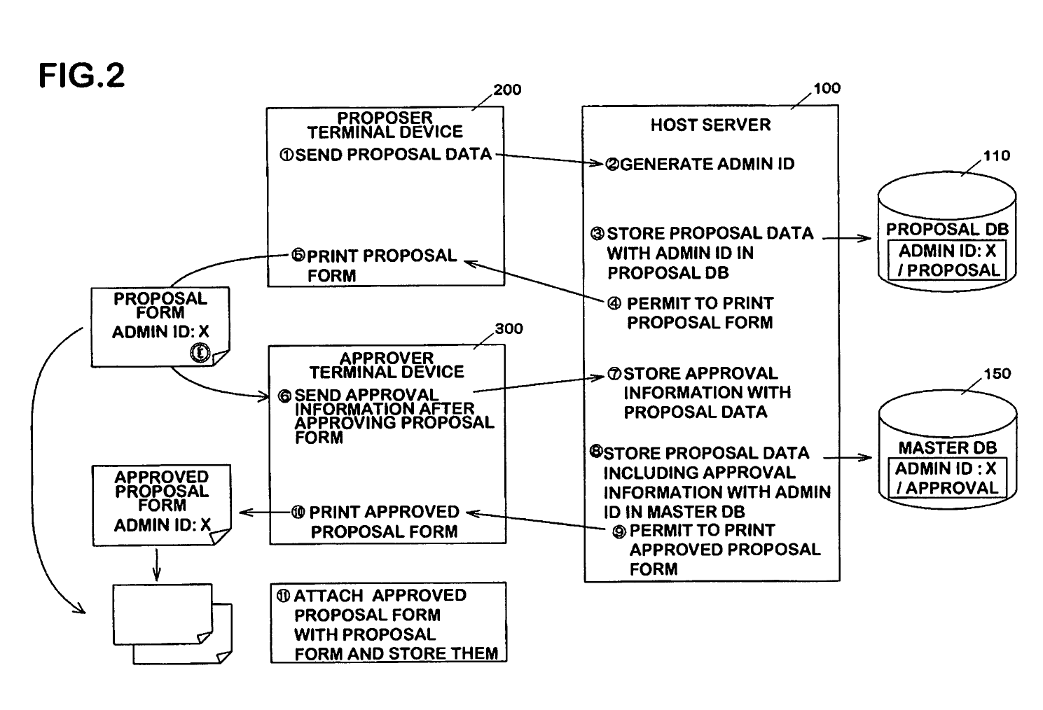

The summary of the process by means of the first embodiment of the external medium-type electronic approval system will be explained with reference to FIG. 2. (1)(which corresponds to circled number in FIG. 2.; the same is applied to the following) The proposer terminal device 200 sends proposal data to the host server 100 according to an operation of a user. (2) The host server 100 generates an administration ID. (3) The host server 100 stores the proposal data on the proposal DB 110 by correlating the proposal data with the administration ID. (4) The host server 100 sends permission to print a proposal form to the proposer terminal device 200. (5) The proposer terminal device 200 prints a proposal form (a paper document).

A user of an approver terminal device 300 receives the printed proposal form. When the user of the approver terminal device 300 approves the content of the proposal form, the user of the approver terminal device 300 puts his or her seal (including an impression, signature, or the like; the same is applied to the following) on the proposal form. (6) After the user of the approver terminal device 300 approves the content of the proposal form, the approver terminal device 300 sends approval information to the host server 100 according to an operation of the user. (7) The host server 100 adds the approval information to the proposal data corresponding to the approved proposal content. (8) The host server 100 stores the proposal data (on which the approval information is added) on a master DB 150 by correlating the proposal data with the administration ID. (9) The host server 100 sends, to the approver terminal device 300, permission to print the approved proposal form which represents the content of the proposal data stored on the master DB 150. (10) The approver terminal device 300 prints the approved proposal form (a paper document). (11) The user of the approver terminal device 300 stores the proposal form with the approved proposal form in a predetermined location. The details of the respective processes of FIG. 2 will be described later with reference to a flowchart.

### 2. Hardware Configuration etc.

2-1. Function Block Diagram

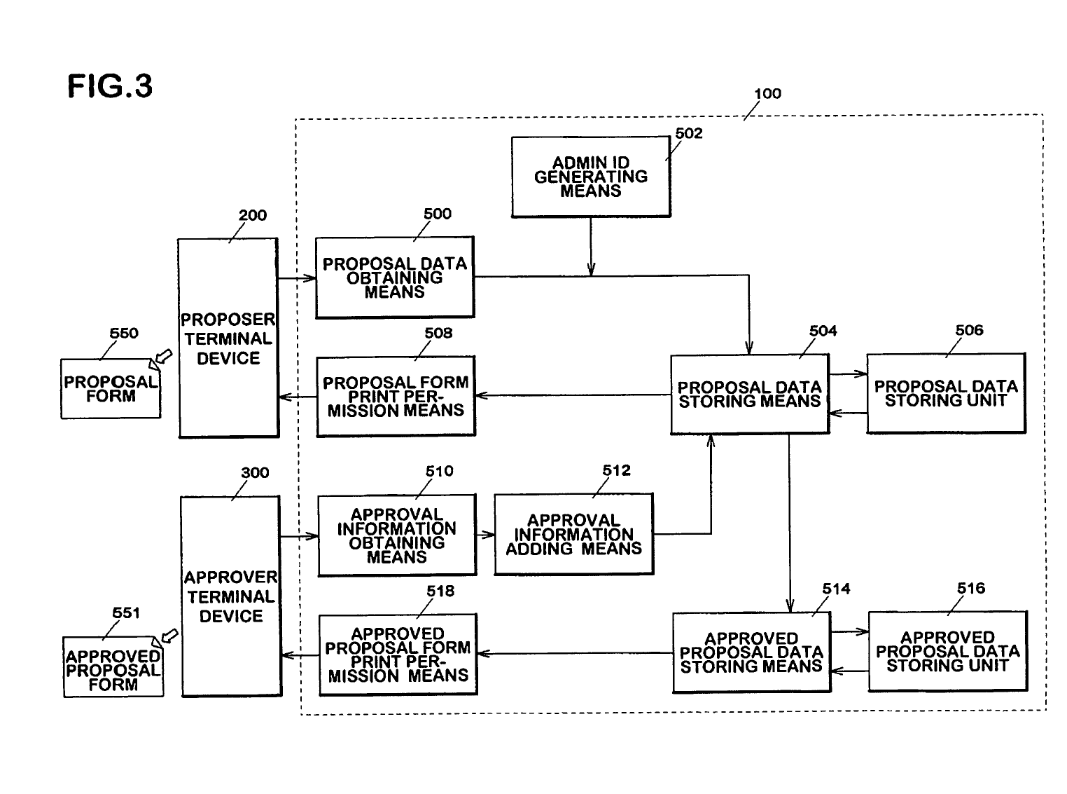

FIG. 3 illustrates a function block diagram of a host server 100 included in the external medium-type electronic approval system. The host server 100 includes: proposal data obtaining means 500 for obtaining proposal data inputted by proposer terminal device 200; administration ID generating means 502 for generating an administration ID which can be used for uniquely identify the proposal data in the system; proposal data storing means 504 for storing the proposal data on proposal data storing unit 506 in correlating the proposal data with the administration ID; and proposal form print permission means 508 for outputting permission for proposer terminal device 200 to print a proposal form with the administration ID. The proposer terminal device 200 prints proposal form 550 when the proposal form print permission means 508 outputs the permission.

The host server 100 further includes: approval information obtaining means 510 for obtaining approval information inputted by approver terminal device 300; approval information adding means 512 for adding approval information to the proposal data; approved proposal data storing means 514 for storing proposal data on approved proposal data storing unit 516; and approved proposal form print permission means 518 for outputting permission for approver terminal device 300 to print an approved proposal form with the administration ID. The approver terminal device 300 prints approved proposal form 551 when the approved proposal form print permission means 518 outputs the permission.

2-2. Host Server

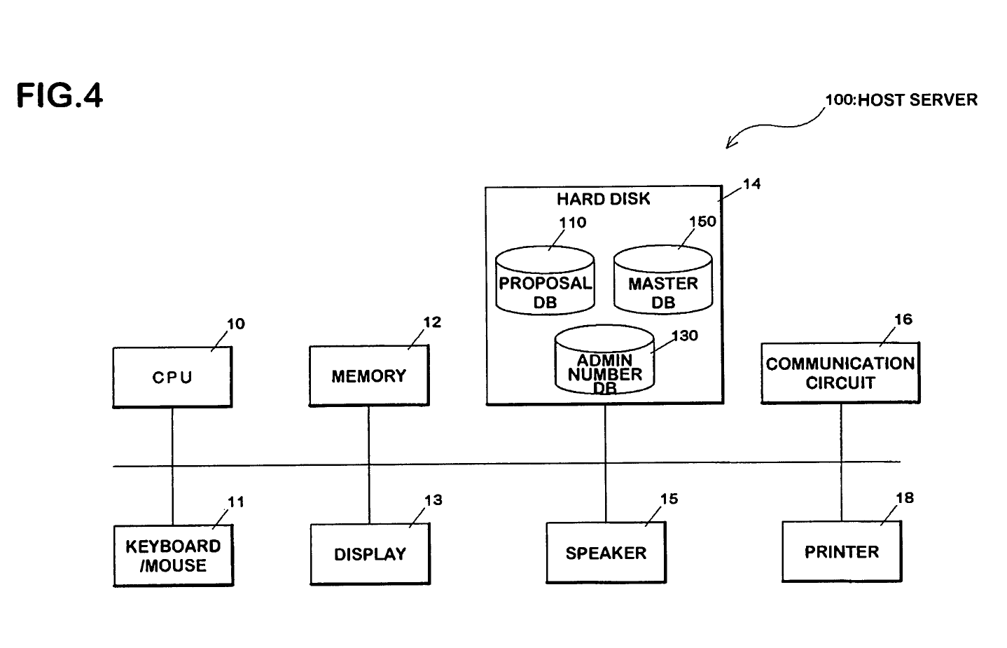

FIG. 4 illustrates a hardware configuration example of the host server 100 illustrated in FIG. 3 by use of a central processing unit (CPU). The host server 100 includes CPU 10, keyboard/mouse 11, memory 12, display 13, hard disk 14, speaker 15, communication circuit 16 for connecting to LAN 400 etc., and printer 18.

The CPU 10 controls operations of the host server 100. The memory 12 acts as a storage area etc. for data processing performed by the CPU 10. The hard disk 14 stores a proposal database 110, an administration number database 130, a master database 150, and a computer program for operating the CPU 10. Operation information generated via operations of the keyboard/mouse 11 is inputted to the CPU 10, and the CPU 10 generates display information and sound information for the display 13, printer 18, or speaker 15 to output.

2-3. Proposer Terminal Device

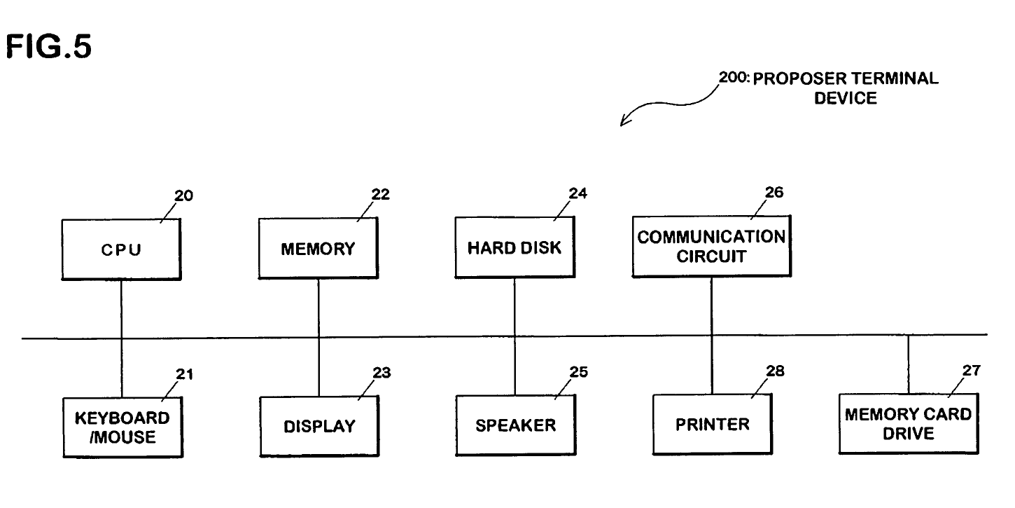

FIG. 5 illustrates a hardware configuration example of a proposer terminal device 200 by use of a CPU included in the external medium-type electronic approval system. The proposer terminal device 200 includes CPU 20, keyboard/mouse 21, memory 22, display 23, hard disk 24, speaker 25, communication circuit 26 for connecting to LAN 400 etc., printer 28, and memory card drive 27.

The CPU 20 controls operations of the proposer terminal device 200. The memory 22 acts as a storage area etc. for data processing performed by the CPU 20. The hard disk 24 stores a computer program for operating the CPU 20. Operation information generated via operations of the keyboard/mouse 21 is inputted to the CPU 20, and the CPU 20 generates display information and sound information for the display 23, printer 28, or speaker 25 to output.

2-4. Approver Terminal Device

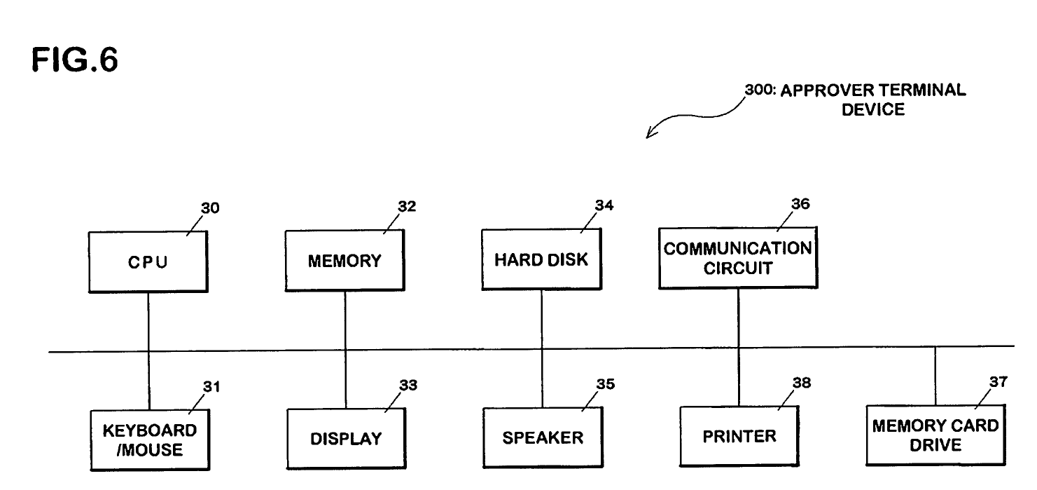

FIG. 6 illustrates a hardware configuration example of an approver terminal device 300 (the configuration of device 301 and 302 are same as device 300) by use of a CPU included in the external medium-type electronic approval system. The approver terminal device 300 includes CPU 30, keyboard/mouse 31, memory 32, display 33, hard disk 34, speaker 35, communication circuit 36 for connecting to LAN 400 etc., printer 38, and memory card drive 37.

The CPU 30 controls operations of the approver terminal device 300. The memory 32 acts as a storage area etc. for data processing performed by the CPU 30. The hard disk 34 stores a computer program for operating the CPU 30. Operation information generated via operations of the keyboard/mouse 31 is inputted to the CPU 30, and the CPU 30 generates display information and sound information for the display 33, printer 38, or speaker 35 to output.

In the embodiments, a dedicated computer program, which is for proposer terminal device 200 or approver terminal device 300 to send predetermined data to host server 100, or to access and receive predetermined screen data for browsing from host server 100, is used in a computer software. Alternative software such as Microsoft”s FrontPage™ can be used to implement the process described herein.

In the embodiments, Microsoft”s Windows™ XP, NT, 2000, 98 or the like is used as an example of operation system of host server 100, proposer terminal device 200, and approver terminal device 300. In the embodiments, the computer program works with the operation system. For alternative embodiments, the computer program works without the operation system.

2-5. Database etc.

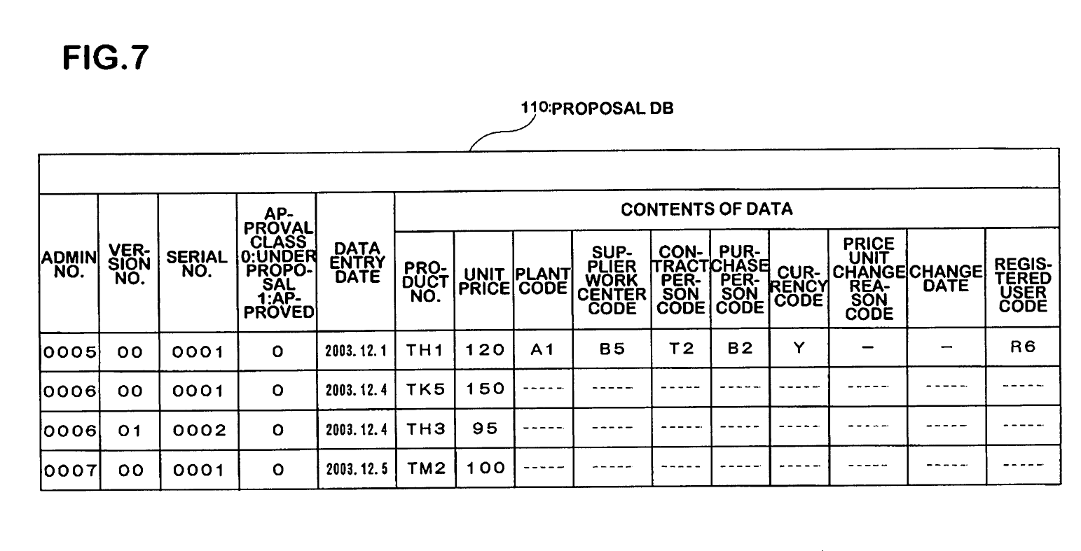

An example of a configuration of a database of the present system according to the embodiment of the present invention will be explained. FIG. 7 illustrates an example of a configuration of the proposal DB 110 which is stored on the hard disk 14 (or the memory 12; the same is applied to the following) by means of the host server 100. The proposal DB 110 has columns in which, for each of the unit price as the proposal item, various pieces of information for the object product, such as a “product number”, a “unit price”, an administration number (administration ID) described later, a version number (an version No., or an additional number, or an edition number), a serial number (a sequence No.), an “approval classification” indicative of whether or not the proposal is approved, and a “data entry date” indicative of the date on which the unit price is registered are stored. Besides, the proposal DB 110 has columns in which, as the proposal information, various pieces of information, such as a “plant code”, a “code of supplier work center, a “code of a person in charge of contract”, a “code of a person in charge of purchase”, a “currency code”, a “code of reason of unit price change”, a “date of change”, and a “code of a registered user” are stored.

The version number is the same concept as a branch number which increases (increments) when the proposal content (the unit price registration) administrated with the same administration number is corrected. The serial number is the same concept as a branch number which, when a plurality of unit prices are registered with a single proposal, identifies each of the plurality of unit prices registered.

In the embodiment, the “unit price registration” of the product is exemplified as the proposal information, but, as the proposal information, the request for purchase (an order for purchase), the request for production (an order for production), or the like may be adopted. When treating the plurality of pieces of proposal information, instead of (or in addition to) those shown in FIG. 7, for example, the proposal DB 110 can store a “unit price for contract purchase”, a “unit number for purchase”, an “estimate issue date”, a “cost for subcontract material”, a “cost for subcontract”, a “production factory code”, “an item list before specification change”, a “specification change number”, a “classification of order leading time”, etc.

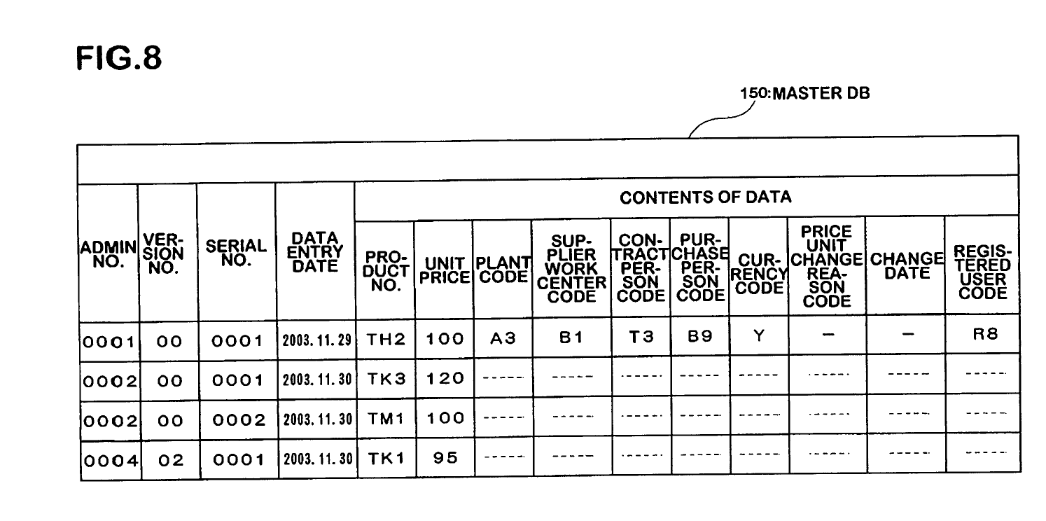

FIG. 8 illustrates an example of a configuration of a master DB 150 which is stored on the hard disk 14 (or the memory 12; the same is applied to the following) by means of the host server 100. The master DB 150 has columns in which the information including the “product number” and the “unit price” of the object product, which are the content of the approved unit price registration, and various pieces of information such as the administration number, the version number, the serial number, and the data entry date are stored. Moreover, according to the management of the present system, there is a case in which information stored in the master DB 150 and the contents of a proposal list and (or) a master update list described later are correlated or are not needed to be correlated with information other than the administration number or the like. In such a case, the master DB 150 may not store all or part of the information of the administration number, the version number, the serial number, and the data entry date.

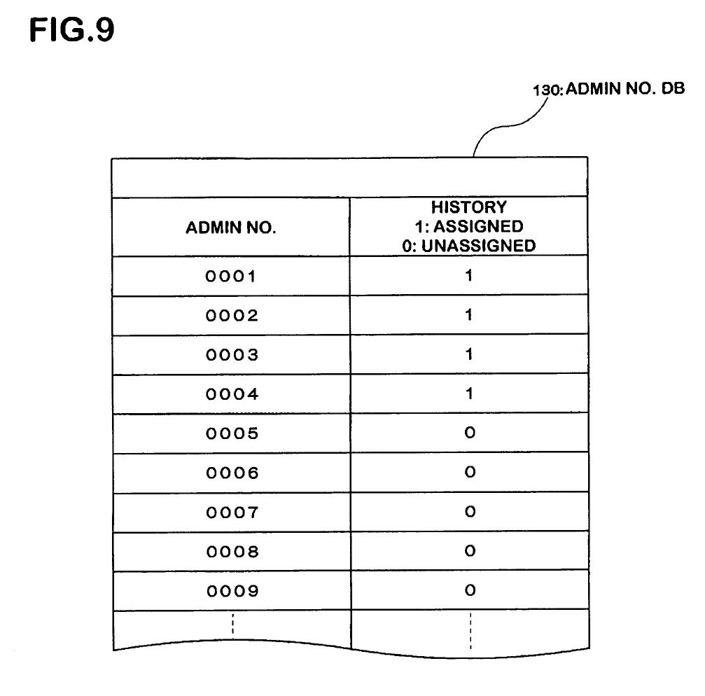

FIG. 9 illustrates an example of a configuration of the administration number DB 130 which is stored on the hard disk 14 (or the memory 12; the same is applied to the following) by means of the host server 100. The administration number DB 130 has columns in which various pieces of information, such as the “administration number” which can be used for uniquely identifying the proposal data of the unit price registration in the external medium-type electronic approval system and a “history” indicative of whether or not the administration number is allocated in the system, are stored. Specifically, the administration number in which “1” is stored in the history represents one already used in the system (assigned), while the administration number in which “0” is stored in the history represents one usable in the system (unassigned). In the administration number DB 130, the administration numbers 0001, 0002, 0003, 0004, . . . are sequentially stored. Moreover, in the embodiment, it is assumed that the administration number having a constant number is stored on the database in advance. However, the present invention is not limited to this configuration. For example, a CPU 10 may store an administration number as a “next obtaining administration number” on the hard disk 14 or the like. In this case, when the proposal data is inputted, the CPU 10 sets the “next obtaining administration number” as the administration number corresponding to the proposal data and increases (for example, increases by 1) the “next obtaining administration number”. The increased “next obtaining administration number” is used as an administration number corresponding to proposal data which is subsequently inputted.

### 3. Function of Device

The correspondence between functions described in the embodiments and a part of functions, of which proposer terminal device 200, approver terminal device 300, host server 100 in FIG. 1 and constructions of host server 100 in FIG. 3, will be described below as examples.

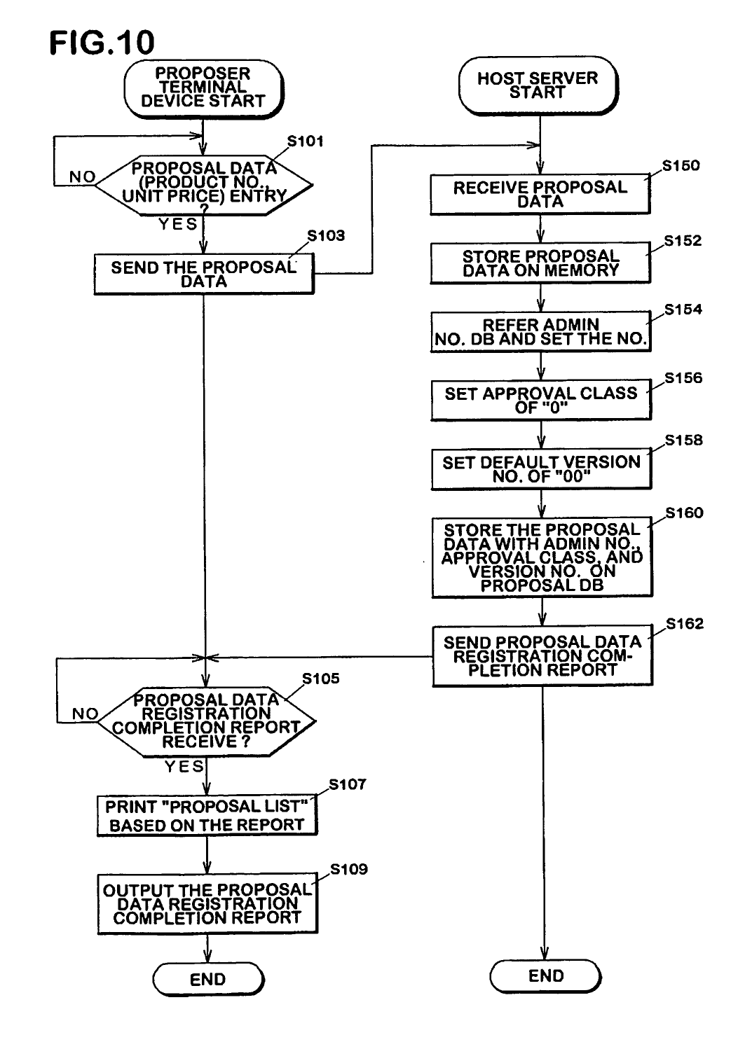

The “proposer terminal device” corresponds to proposer terminal device 200 in the embodiments. The proposal data corresponds to proposal data inputted at step 101 in FIG. 10 or the like. The proposal data obtaining means has a function for obtaining proposal data. For example, the proposal data obtaining means corresponds to CPU 10 of host server 100 that executes a process of step 150 in FIG. 10.

The “administration ID” corresponds to an administration number, combination of the administration number and a serial number (or a version number), or combination of the administration number, serial number and version number, which is set by CPU 10 at the process of step 154 in FIG. 10. The “administration ID generating means” has a function for generating an administration ID. For example, the administration ID generating means corresponds to CPU 10 that generates and administration ID etc. at a process of step 154 in FIG. 10.

The “proposal data storing unit” corresponds to proposal database 110. The “proposal data storing means” has a function for storing proposal data. For example, the proposal data storing means corresponds to CPU 10 that executes a process of step 160 in FIG. 10.

The “proposal form” corresponds to a proposal list that is printed at step 107 in FIG. 10. The “proposal form print permission means” has a function for outputting permission to print a proposal form. For example, the proposal form print permission means corresponds to CPU 10 that sends proposal data entry completion report at a process of step 162 in FIG. 10.

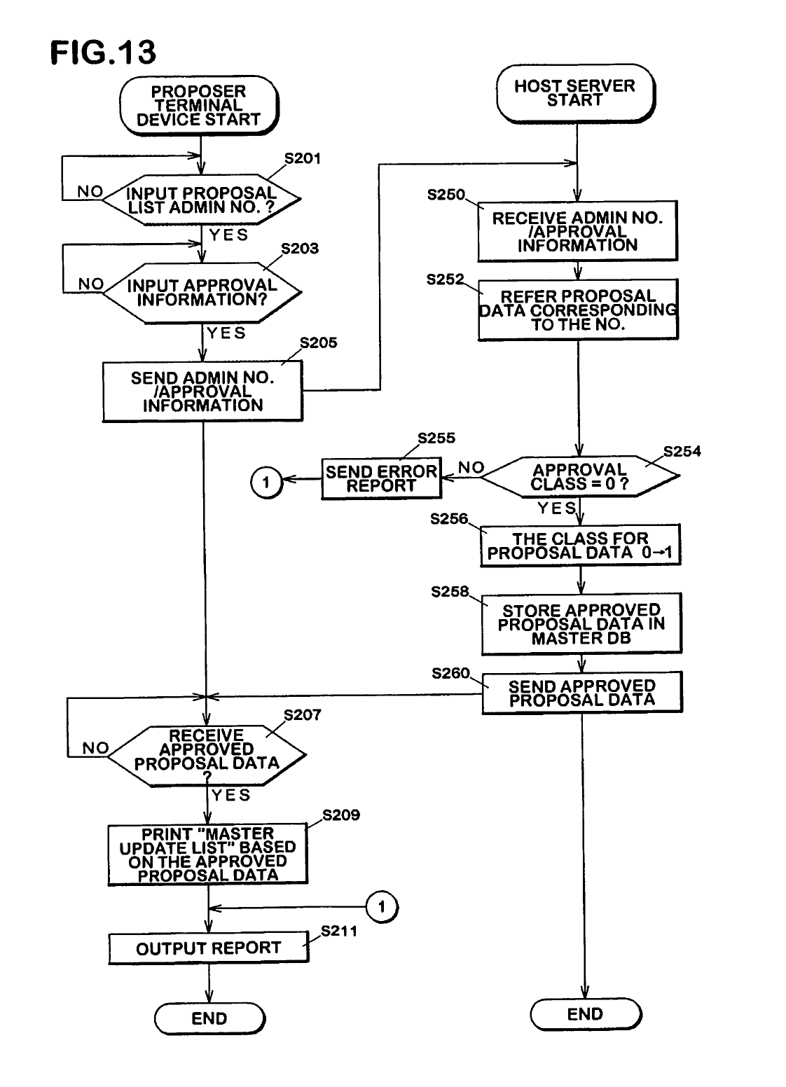

The “approver terminal device” corresponds to approver terminal device 300. The “approval information” corresponds to approval information inputted at step 203 in FIG. 13. The “approval information obtaining means” has a function for obtaining approval information. For example, the approval information obtaining means corresponds to CPU 10 that obtains flag information with respect to an approval at a process of step 250 in FIG. 13. The “approval information adding means” has a function for adding approval information. For example, the approval information adding means corresponds to CPU 10 that rewrites data of “0” in a column of approval class to “1” at a process of step 256 in FIG. 13.

The “approved proposal data storing unit” corresponds to master database 150. The “approved proposal data storing means” has a function for storing approved proposal data. For example, the approved proposal data storing means corresponds to CPU 10 that executes a process of step 258 in FIG. 13.

The “approved proposal form” corresponds to master update list that is printed at step 209 in FIG. 13. The “approved proposal form print permission means” has a function for outputting permission to print an approved proposal form. For example, the approved proposal form print permission means corresponds to CPU 10 that sends approved proposal data at a process of step 260 in FIG. 13.

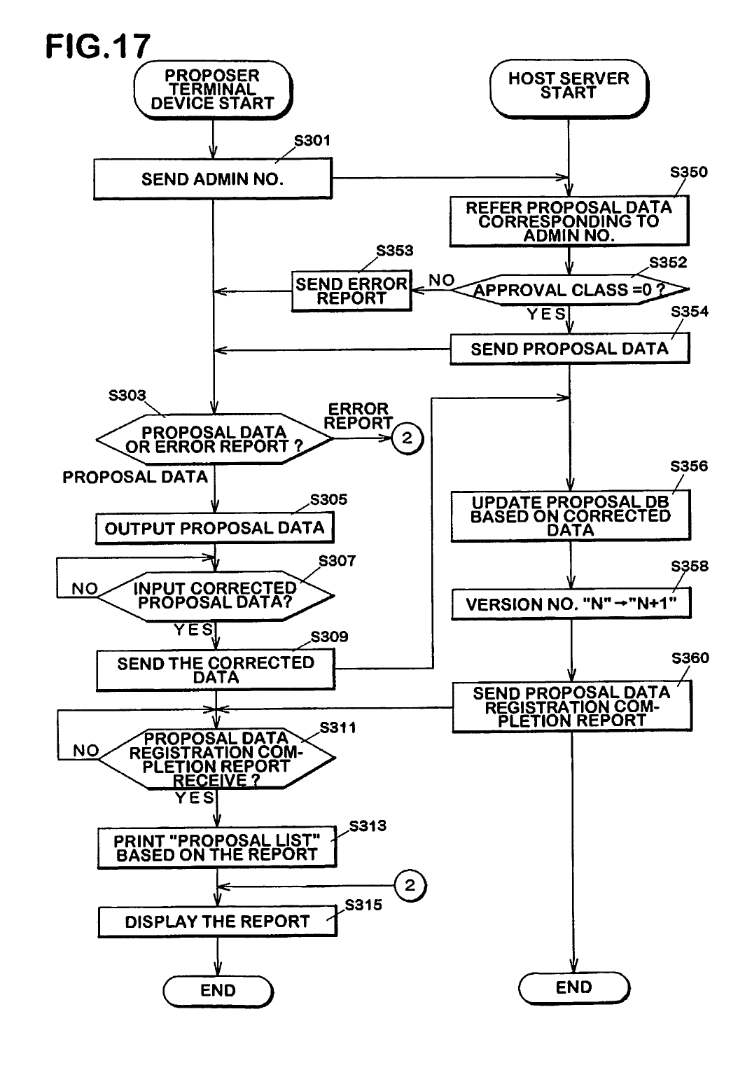

The “correction request” is information for requesting to correct proposal data. For example, the correction request corresponds to corrected proposal data to be sent at step 309 in FIG. 17.

### 4. First Embodiment

Hereinafter, as a first embodiment of an external medium-type electronic approval system of the embodiment shown in FIG. 2, a proposal information registration processing program, an approval processing program, and a reproposal information registration processing program will be explained in due order.

4-1. Proposal Information Registration Process

A process in which a user of a proposer terminal device 200 accesses to a host server 100 and inputs a proposal content of a unit price registration will be explained. FIG. 10 is a flowchart of a proposal information registration processing program which is executed by a CPU 20 of the proposer terminal device 200 and a CPU 10 of the host server 100. It is assumed that, before starting the process by the proposal information registration processing program, a “proposal information registration menu” of a unit price approval system included in the external medium-type electronic approval system is selected by the user of the proposer terminal device 200.

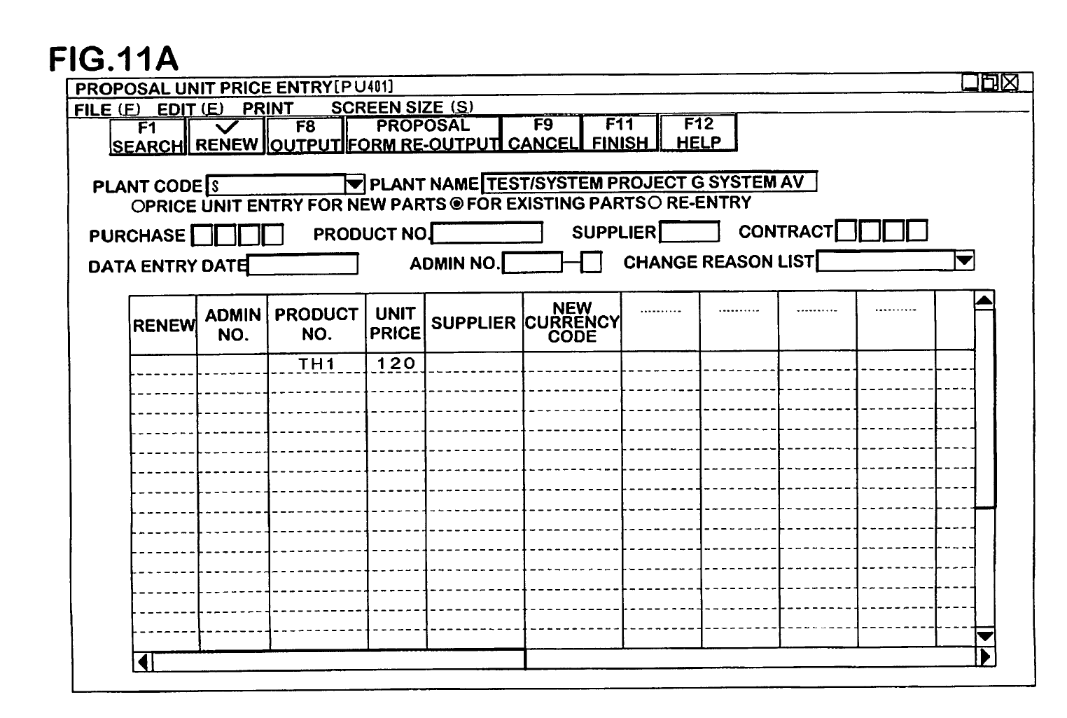

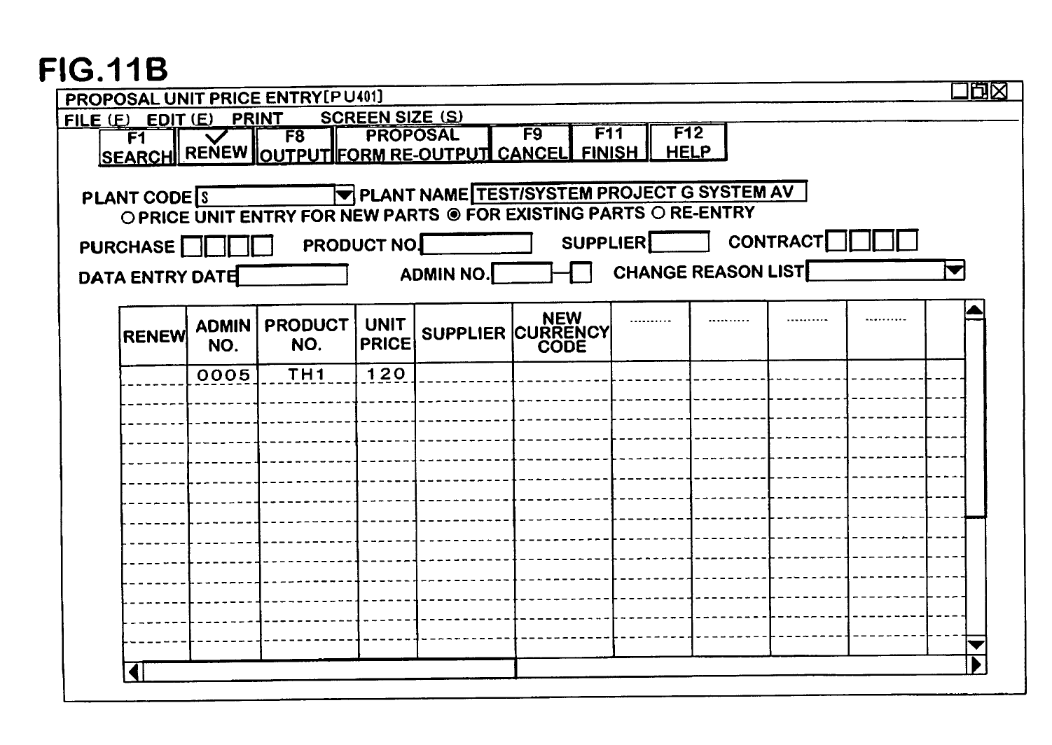

The CPU 20 of the proposer terminal device 200 judges whether or not the proposal data including information such as the “product number” and the “unit price” is inputted through the operation of a keyboard/mouse 21 by the user (step S101 of FIG. 10). FIG. 11A illustrates an example of a screen which is displayed on a display 23 of the proposer terminal device 200 at the time of the input of the proposal data. Here, for example, it is assumed that information such as a product number “TH1” and a unit price “120” (Yen) is inputted to a memory 22 (or a hard disk 24; the same is applied to the following) of the proposer terminal device 200.

In the step S101, if it is judged that the proposal data is inputted, the CPU 20 sends the inputted proposal data to the host server 100 (S103). The judgment by the CPU 20 regarding whether or not the proposal data is already inputted is performed by the presence or absence of a click operation of a list “output” button of FIG. 11A, for example.

The CPU 10 of the host server 100 receives the proposal data (S150) and stores it on a memory 12 (S152). The CPU 10 sets the administration number with reference to a administration number DB 130 (S154). Specifically, the CPU 10 obtains the administration numbers, in which the columns of “history” are “0”, among the administration numbers stored in the administration number DB 130 shown in FIG. 9 in the ascending order. In the case of FIG. 9, the CPU 10 stores the administration number “0005” on the memory 12. The CPU 10 rewrites the column of “history” corresponding to the stored administration number to “1”.

The CPU 10 sets an approval classification to “0” on the memory 12 (S156). The CPU 10 sets a default version number “00” of a version number on the memory 12 (S158). The CPU 10 stores the proposal data, which is stored on the memory 12, on a proposal DB 110 by correlating the proposal data with the administration number, the approval classification, and the version number (S160). Here, the CPU 10 stores the proposal data of the product number “TH1” and the unit price “120” by correlating the proposal data with the administration number “0005”, the approval classification “0”, and the version number “00”. Moreover, since the proposal data is one type, “0001” is stored as the “serial number”. In a single proposal information registration process, when two types of proposal data are registered, “0001” and “0002” are respectively stored as the serial numbers.

The CPU 10 sends a proposal data registration completion report including information regarding the proposal data stored on the proposal DB 110 (various pieces of information of the administration number, the version number, the serial number, the data entry date, the product number, and the unit price) to the proposer terminal device 200 and ends the process (S162). The proposal data registration completion report sent by the CPU 10 includes the information which can be used for setting (assigning) the permission to print the information regarding the registered proposal data to the proposer terminal device 200. The setting of permission to print may be executed, for example, by using a general technique regarding the setting of authority of a user in a computer system.

The CPU 20 judges whether or not the proposal data registration completion report is received (S105). If it is judged that the proposal data registration completion report is received, the CPU 20 prints the “proposal list” via a printer 28 based on the proposal data registration completion report (S107). The CPU 20 outputs the proposal data registration completion report to a display 23 and ends the process (S109).

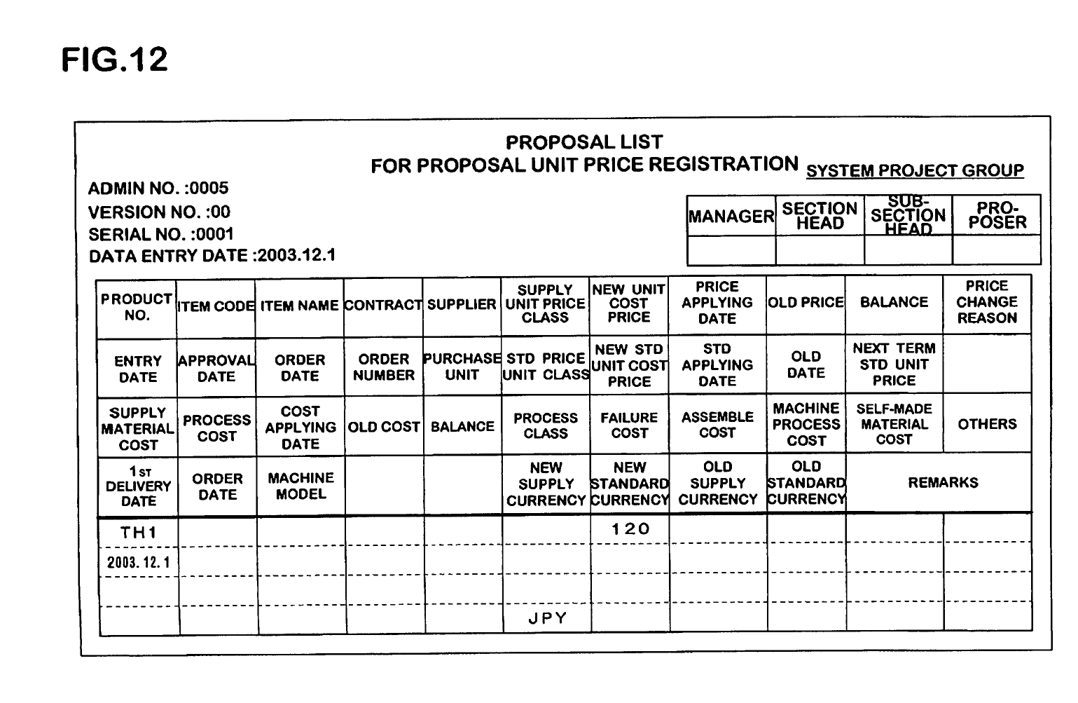

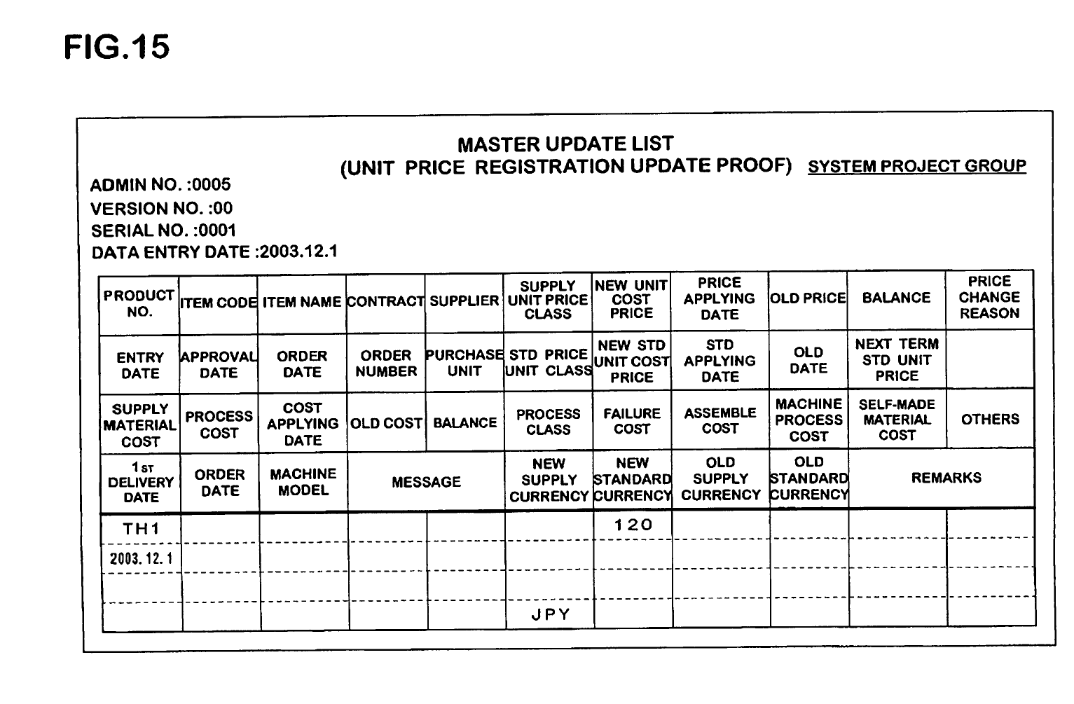

FIG. 12 illustrates an example of the “proposal list” (paper document) which is printed through the process of the step S107. In the proposal list, various pieces of information such as the administration number, the version number, the serial number, the data entry date, the product number, the unit price, etc. are specified. In the embodiment, a “unit price registration proposal form (for registration)” shown in FIG. 12 is shown as an example of the proposal list. The proposal list can be used for storage by correlating with the “master update list” (FIG. 15) described later. In the process of the step S107 of FIG. 10, in addition to the document stored by correlating with the “master update list”, a “unit price registration proposal form (section reservation)” as the proposal list to be kept in a section to which the proposer belongs and/or a “unit price notice form (buyer reservation)” as a document to be submitted to a buyer may be printed.

FIG. 11B illustrates an example of a screen of the approval data registration completion report which is displayed on the display 23 of the proposer terminal device 200 through the process of the step S109.

4-2. Approval Process

In the external medium-type electronic approval system, electronic approval (including the record of the approval information by means of the computer system) is performed, in combination with the paper document. Therefore, on the assumption that an approval process described later is performed, the proposal content displayed on the proposal list is assumed to have been approved by a user (approver) of the approver terminal device 300 already. Specifically, an approver receives the proposal list, which is printed after the above-described proposal information registration process, from the user (the proposer) of the proposer terminal device 200. (See the step S107 of FIG. 10 and FIG. 12.) Then, after examining the proposal content displayed on the proposal list, the approver decides approval and, for example, seals a sealing part of the proposal list. After the above-described process on the paper document, the user of the approver terminal device 300 accesses to the host server 100 and performs a process of storing the information that the proposal content of the unit price registration is approved. Moreover, it is assumed that, before starting the process by the approval processing program, “an approval menu” of the unit price approval system included in the external medium-type electronic approval system is selected by the user of the approver terminal device 300.

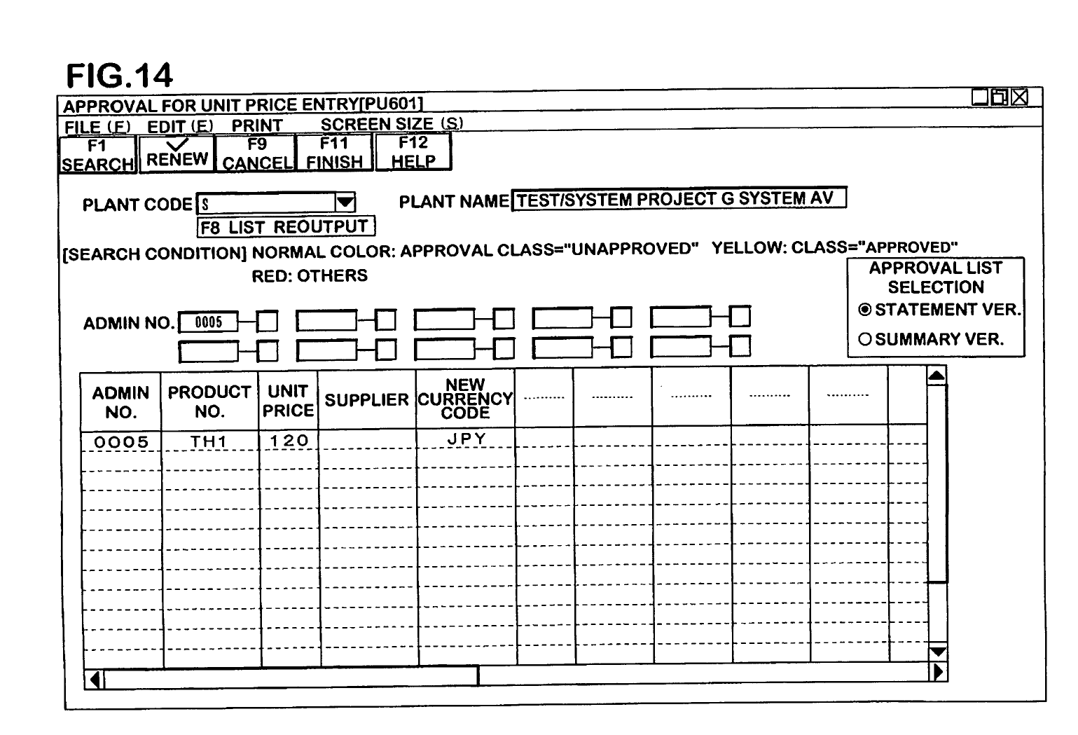

FIG. 13 illustrates a flowchart of the approval processing program which is executed by a CPU 30 of the approver terminal device 300 and the CPU 10 of the host server 100. The CPU 30 of the approver terminal device 300 judges whether or not “the administration number” is inputted through the operation of a keyboard/mouse 31 by the user (step S201 of FIG. 13). Moreover, when a plurality of unit price registrations are made with a same administration number and when some of the plurality of unit price registrations are approved, the combination of the administration number and the serial number is inputted. (For example, in the case of the product number TK5 of FIG. 7, “00060001” is inputted as the administration number.) If it is judged that the administration number is inputted, the CPU 30 judges whether the approval information is inputted (step S203). FIG. 14 illustrates an example of a screen which is displayed on a display 33 of the approver terminal device 300 when the approval process is performed. If the administration number of the approved proposal information is inputted to a box for “administration number” shown in FIG. 14 through the operation of the keyboard/mouse 31 by the user, the proposal information corresponding to the administration number is displayed. At this time, it is preferable for the approver to confirm that the above-described sealed content of the proposal list and the content of the proposal information displayed on the display 33 matches with each other. In the screen shown in FIG. 14, if a click operation of an update button (v point mark) or the like is performed through the operation of the keyboard/mouse 31 by the user, then it is judged that the approval information with respect to the proposal information corresponding to the administration number is inputted. Here, it is assumed that the information of the administration number “0005” and the flag information indicative of approval as an example are inputted to a memory 32 (or a hard disk 34; the same is applied to the following) of the approver terminal device 300.

In the step S203, when it is judged that the approval information is inputted, the CPU 30 sends the information of the administration number and the flag information regarding the approval stored on the memory 32 to the host server 100 (step S205).

The CPU 10 of the host server 100 receives the information of the administration number and the flag information regarding the approval (step S250). The CPU 10 searches the proposal DB 110 and references the proposal data corresponding to the received administration number (step S252). Here, in the proposal DB 110 of FIG. 7, the proposal data (the content regarding a product number: TH1 and a unit price: 120 (Yen)) corresponding to the administration number 0005 is referenced.

The CPU 10 judges whether or not the column of the approval classification of the referenced proposal data is “0” (step S254). In the case where it is not “0”, that is, in the case of “1” indicating that it is already approved, the CPU 10 sends an error report to the approver terminal device 300 (step S255). On the other hand, when the column of the approval classification is “0”, the CPU 10 rewrites the information of “0” of the column of the approval classification to “1” (corresponding to “approved”) (step S256).

The CPU 10 stores the proposal data (approved proposal data) in which the column of the approval classification is substituted with “1” at the step S256 on the master DB 150 (FIG. 8) (step S258).

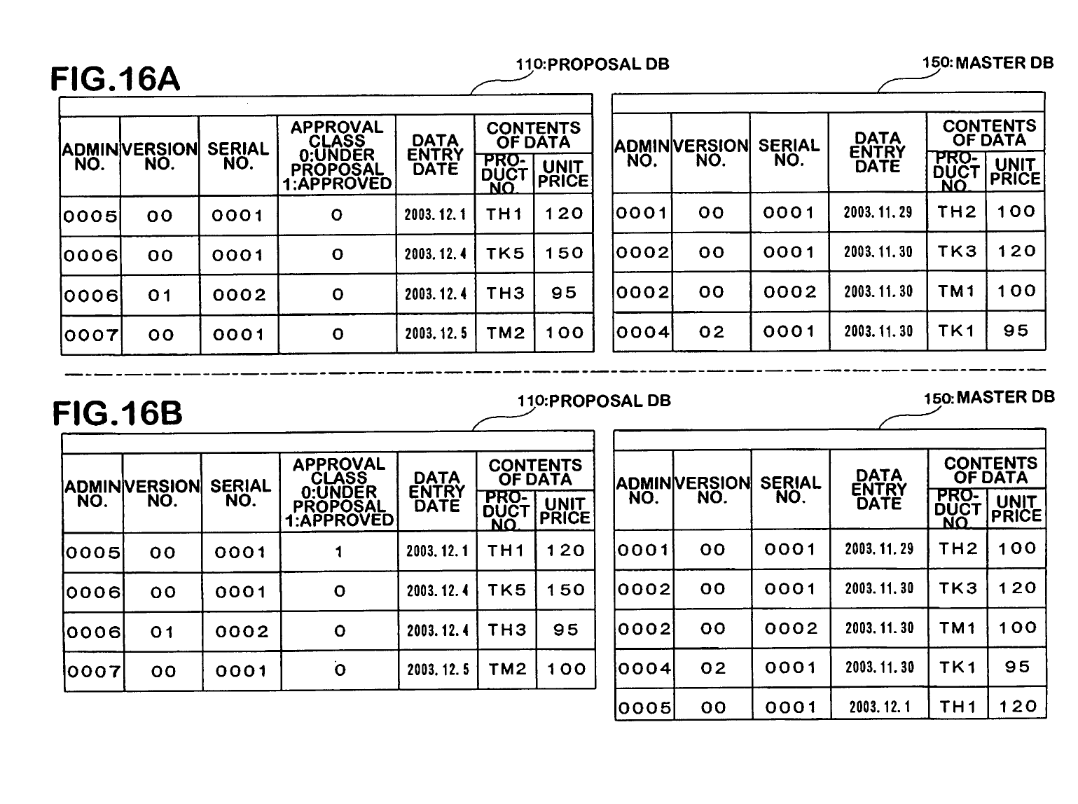

FIG. 16 illustrates an example of the stored contents of the proposal DB 110 and the master DB 150 before and after the steps S256 and S258. FIG. 16A illustrates the stored contents of the proposal DB 110 and the master DB 150 before the process of the step S256. The approval classification of the proposal data of the administration number 0005 is “0”. On the other hand, FIG. 16B illustrates the stored contents of the proposal DB 110 and the master DB 150 after the processes of the steps S256 and S258. The approval classification of the proposal data of the administration number 0005 is “1” (through the process of the step S256) and the content (the product number, the unit price, the administration number, the version number, the serial number, and the data entry date) of the proposal data of the administration number 0005 is stored on the master DB 150 (through the process of the step S258).

The CPU 10 sends the information (various pieces of information such as the administration number, the version number, the serial number, the data entry date, the product number, and the unit price) regarding the approved proposal data stored on the proposal DB 110 (or the master DB 150) to the approver terminal device 300 and ends the process (step S260). The information regarding the approved proposal data sent by the CPU 10 includes the information which can be used for setting (assigning) the permission to print the information regarding the approved proposal data stored on the master DB 150 to the approver terminal device 300.

The CPU 30 judges whether or not the approved proposal data is received (step S207) and, if it is judged that the approved proposal data is received, prints the “master update list” via a printer 38 based on the content of the approved proposal data (step S209). The CPU 30 outputs the report content to the display 33 and ends the process (step S211). The report content is either the report that the approval of the proposal data is completed or the “error report” which is received through the process of the step S255.

FIG. 15 illustrates an example of the “master update list (unit price registration update proof)” (the paper document) which is printed through the process of the step S209. In the master update list, various pieces of information, such as the administration number, the version number, the serial number, the data entry date, the product number, the unit price, etc., are specified as the approved proposal content (the updated content in the master DB 150).

Through the above-described processes, the user of the approver terminal device 300 obtains the “proposal list (sealed) (FIG. 12)” printed through the above-described proposal information registration process and the “master update list (FIG. 15)” printed through the process of the step S209.

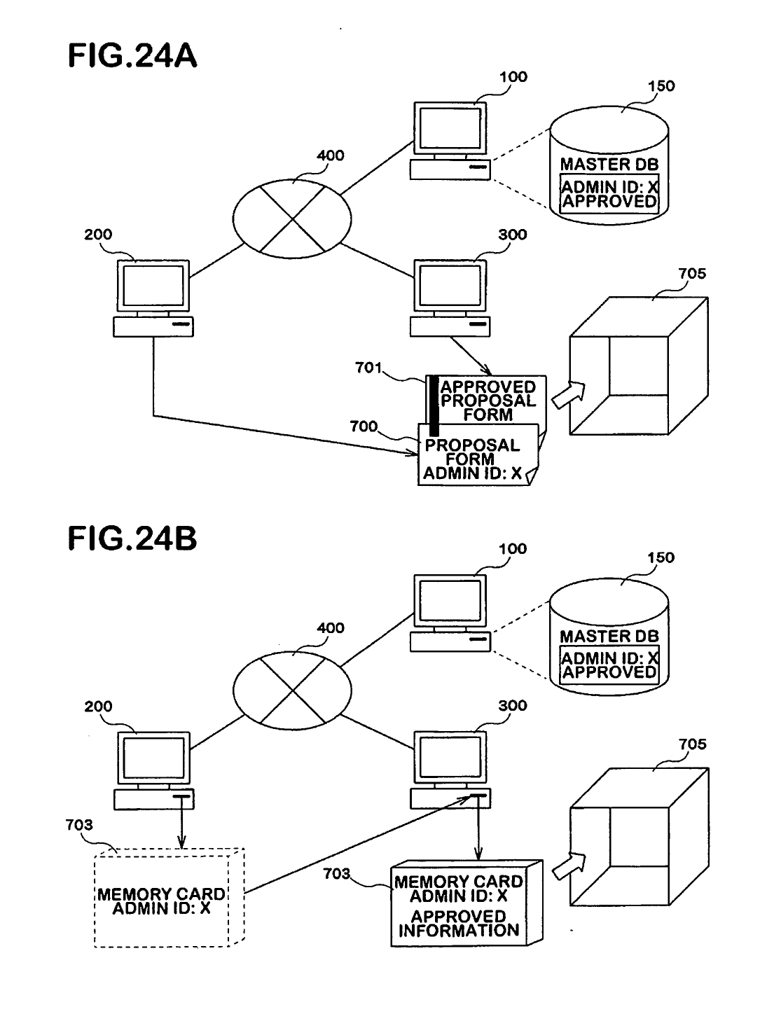

The “proposal list (sealed)” illustrates, on the paper document, the proposal content and the fact that the proposal content is approved. On the other hand, the “master update list” represents the fact on the paper document that the proposal content included in the list is stored on the master DB 150 as the approved proposal data. On both the paper documents, the same “administration number” etc. are printed. Therefore, when keeping the paper documents regarding the proposal and approval, it is preferable that the paper documents of the “proposal list (sealed)” and the “master update list” are kept by correlating them with each other. Specifically, as exemplified in FIG. 24A, the proposal list (sealed) 700 and the master update list 701 are attached to each other with a stapler or paste or the like as a pair of paper documents which are correlated with the same administration number (corresponding to the state in which “the proposal form and the approved proposal form are attachable to each other”), and then are kept in a predetermined storage location 705.

The user of the approver terminal device 200 can grasp that the proposed content is approved by confirming the approval on the display 23 by accessing to the host server 100 and executing the search based on the “administration number”, or by confirming that the two paper documents of the “proposal list (sealed)” and the “master update list” are kept.

In the embodiment, as for the proposal data stored on the proposal DB 110, the CPU 10 continuously stores the proposal data even after it becomes the approved proposal data through the approval process, but the present invention is not limited to this configuration. As another embodiment, the CPU 10 may delete the proposal data, which becomes the approved proposal data through the approval process, from the proposal DB 110. Further, even before approval, the CPU 10 may delete the proposal data, the data entry date of which has passed a predetermined period (for example, 3 months) or more, from the proposal DB 110.

In the embodiment, on the condition that the content of the proposal data is stored on the master DB 150, the master update list in the approver terminal device 300 is printed. (See the steps S258, S260, and S209 of FIG. 13.) As another embodiment, at the step S256, on the condition that the information of the approval classification is substituted, the master update list in the approver terminal device 300 may be printed. In this case, the CPU 10 executes the process in the order of the step S260 and the step S258 after the step S256.

4-3. Reproposal Information Registration Process

A process in which the user of the proposer terminal device 200 accesses to the host server 100 and corrects the proposal content of the unit price registration will be explained. Through this process, for example, when the approver does not approve the proposal content or when the correction of the proposal content is suggested, the proposer can input corrected proposal data. FIG. 17 illustrates a flowchart of a reproposal information registration processing program which is executed by the CPU 20 of the proposer terminal device 200 and the CPU 10 of the host server 100. Moreover, it is assumed that, before starting the process by the reproposal information registration processing program, a “reproposal information registration menu (proposal data update menu)” in the unit price approval system included in the external medium-type electronic approval system is selected by the user of the proposer terminal device 200.

The CPU 20 of the proposer terminal device 200 sends the information of the “administration number” inputted through the operation of the keyboard/mouse 21 by the user to the host server 100 (step S301). Moreover, when a plurality of unit price registrations are made with a single administration number and when some of the plurality of unit price registrations are registered again, the combination of the administration number and the serial number may be inputted. (For example, in the case of the product number TK5 of FIG. 7, “00060001” is inputted as the administration number.)

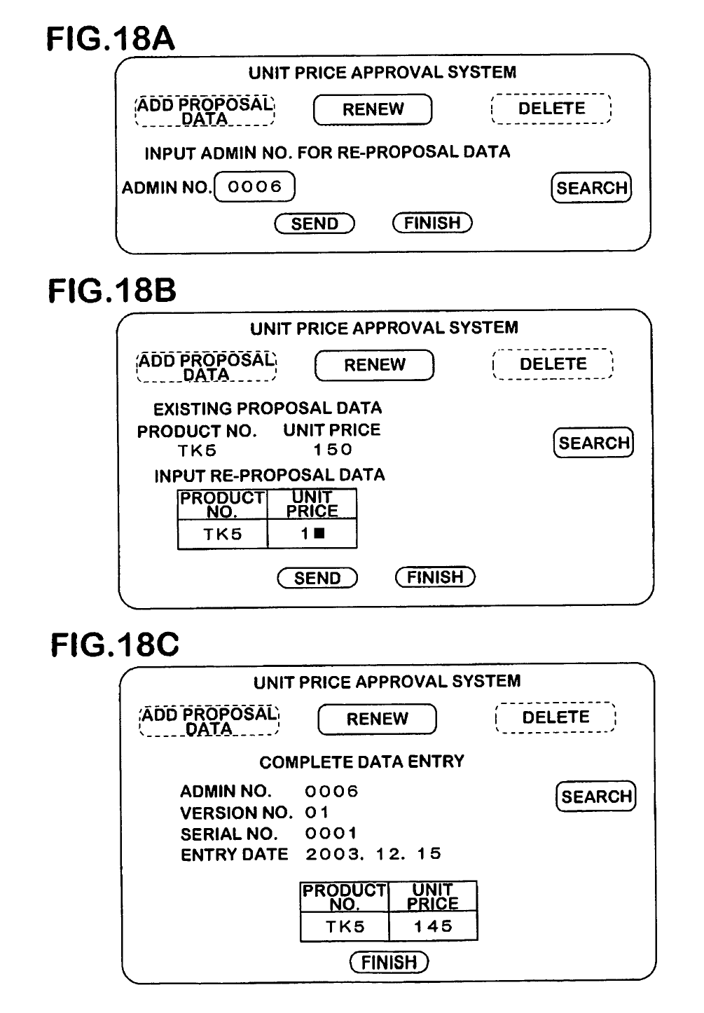

FIG. 18A illustrates an example of a screen which is displayed on the display 23 of the proposer terminal device 200 at the time when the administration number is inputted. Here, it is assumed that “0006” is inputted as an example of the administration number.

The CPU 10 of the host server 100 searches the proposal DB 110 and references the proposal data corresponding to the received administration number (step S350). Here, in the proposal DB 110 of FIG. 7, the proposal data (the content regarding the product number: TK5 and the unit price: 150 (Yen)) corresponding to the administration number 0006 (the serial number 0001) is referenced.

The CPU 10 judges whether or not the column of the approval classification of the referenced proposal data is “0” (step S352). In the case where it is not “0”, that is, in the case where “1” indicating that it is already approved is stored due to the insufficient contact between the proposer and the approver, for example, due to an error, the CPU 10 sends an error report to the proposer terminal device 200 (step S353).

In the step S352, when the approval classification is “0”, the CPU 10 sends the proposal data to the proposer terminal device 200 based on the information stored in the proposal DB 110 (step S354). The CPU 20 judges whether the received information is either the proposal data or the error report (step S303). When the received information is the error report, the CPU 20 displays the error report on the display 23 through the process of the step S315.

On the other hand, when the received information is the proposal data, the CPU 20 displays the proposal data on the display 23 (step S305). FIG. 18B illustrates an example of a screen which is displayed on the display 23 of the proposer terminal device 200 at the step S305. The CPU 20 judges whether or not the corrected proposal data (information regarding the product number and the unit price) through the operation of the keyboard/mouse 21 by the user is inputted (step S307). If it is judged that the corrected proposal data is inputted, the CPU 20 sends the corrected proposal data to the host server 100 (step S309). Here, the corrected proposal data sent includes information (correction command) regarding a correction command of the proposal data.

The CPU 10 receives the corrected proposal data and updates the proposal DB 110 based on the corrected proposal data (step S356). Here, there is shown an example in which the proposal data (the product number: TK5 and the unit price: 150) of the administration number 0006 is updated to the corrected proposal data (the product number: TK5 and the unit price: 145). The CPU 10 changes (increases by 1) the version number “N” to “N+1” (step S358). Here, the CPU 10 rewrites the version number “00” corresponding to the administration number 0006 of the proposal DB 110 shown in FIG. 7 to “01” (corresponding to “the generation of a new administration ID which can be discriminated from the old administration ID”). The CPU 10 sends a proposal data registration completion report to the proposer terminal device 200 and ends the process (step S360). The proposal data registration completion report sent by the CPU 10 includes the information which can be used for setting (assigning) the permission to print the information regarding the registered proposal data to the proposer terminal device 200.

The CPU 20 judges whether or not the proposal data registration completion report is received (step S311), and, if it is judged that it is received, prints the “proposal list” via the printer 28 based on the content of the corrected proposal data input through the step S307 (step S313). The “proposal list” (paper document) printed through the process of the step S313 is the same as that shown in FIG. 12. However, here, the proposal list displays the corrected unit price registration and the “version number” which is increased by 1 from that in the old proposal list. In this case, the old proposal list is generally deleted by the user. The CPU 20 outputs the proposal data registration completion report to the display 23 and ends the process (the step S315).

FIG. 18C illustrates an example of a screen of the proposal data registration completion report which is displayed on the display 23 of the proposer terminal device 200 through the process of the step S315.

### 5. Second Embodiment

A second embodiment of the external medium-type electronic approval system of the embodiment shown in FIG. 1 will be explained. The second embodiment describes a case in which approval by two persons is required for a single piece of approval information, based on the assumption that the proposal information registration process is according to the first embodiment. Specifically, based on the condition that, for example, the user of the approver terminal device 300 and the user of the approver terminal device 301 approve the proposal information inputted to the system by the user of the proposer terminal device 200 of FIG. 1, the approval process of the proposal information is completed. Hereinafter, the approval to be performed by the user of the approver terminal device 300 is referenced as a first approval and the approval performed by the user of the approver terminal device 301 is referenced as a second approval. For example, the first approval is to be performed by an inferior approver (for example, an assistant chief of a section) of the section to which the proposer belongs and the second approval is to be performed by a superior approver (for example, a chief of the section or a director). The second embodiment is different from the first embodiment in that a plurality of approvers approve. Therefore, hereinafter, the approval process will be explained by laying emphasis on elements different from the first embodiment.

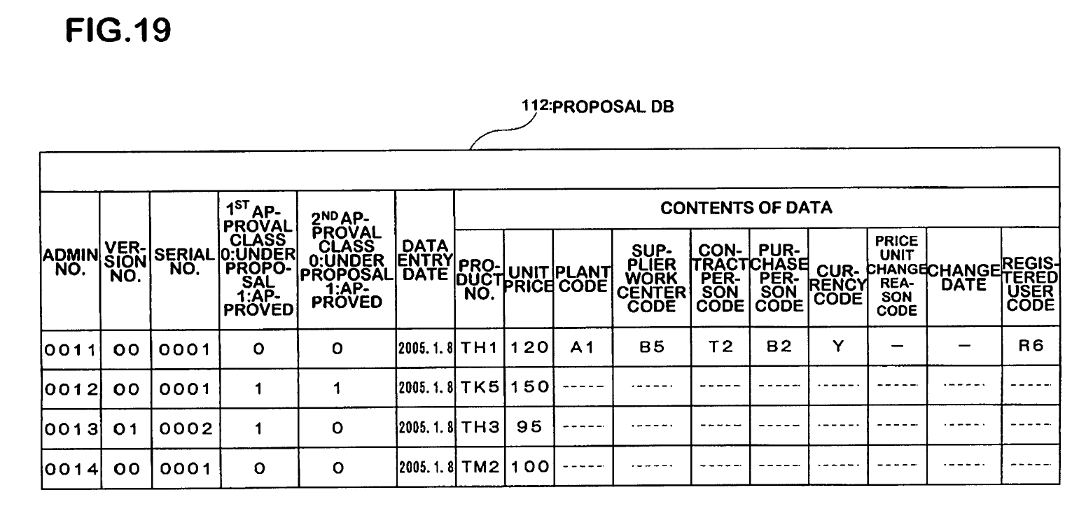

FIG. 19 illustrates an example of a configuration of a proposal DB 112 which is stored on the hard disk 14 by the host server 100. Unlike the first embodiment, in the second embodiment, there are columns in which pieces of information of a “first approval classification” indicating whether or not the first approver approves and a “second approval classification” indicating whether or not the second approver approves are stored.

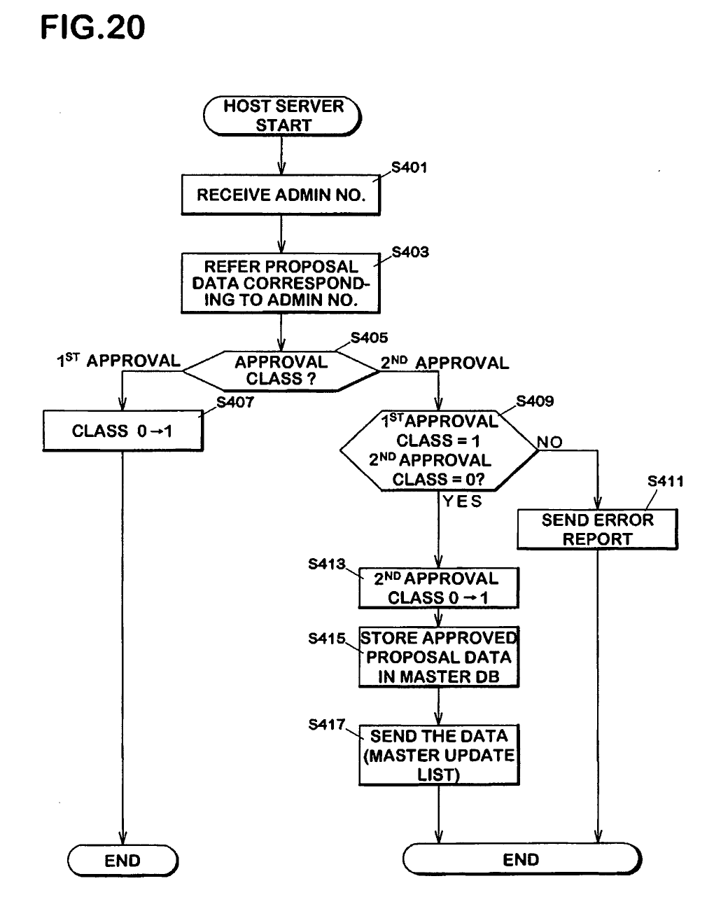

FIG. 20 illustrates a flowchart of an approval processing program which is executed by the CPU 10 of the host server 100. The CPU 10 of the host server 100 receives the information regarding the administration number and the flag information regarding the approval from the approver terminal device 300 or the approver terminal device 301 (step S401). The CPU 10 searches the proposal DB 110 and references the proposal data corresponding to the received administration number (step S403). The CPU 10 judges whether the type of approval is the first approval or the second approval (step S405). Specifically, the CPU 10 judges whether the terminal that has sent the administration number or the like at the step S401 is the approver terminal device 300 used by the first approver or the approver terminal device 301 used by the second approver. As for this judgment, the CPU 10 can use, for example, a user ID (an identification number of a user used in the system) of the terminal device included in the transmission information.

If it is judged that the type of approval is the first approval through the process of the step S405, the CPU 10 rewrites the information of “0” of the column of the approval classification regarding the first approval of the proposal data referenced at the step S403 to “1” and ends the process (step S407).

If it is judged that the type of approval is the second approval through the process of the step S405, the CPU 10 judges whether or not the column information of the approval classification of the first approval is “1” and the second approval is “0”, which are referenced at the step S403 (step S409). If it is judged that the column information of the first approval classification is “1”, the CPU 10 rewrites the information of “0” in the column of the second approval classification of the proposal data to “1” (step S413).

The CPU 10 stores the proposal data (the approved proposal data), in which the column of the approval classification is substituted with “1” through the step S413, on the master DB 150 (FIG. 8) (step S415). The CPU 10 sends the information regarding the approved proposal data stored on the proposal DB 110 (or the master DB 150) to the approver terminal device which has sent the administration number or the like at the step S401 and ends the process (step S417). The information regarding the approved proposal data sent by the CPU 10 includes the information which can be used for setting (assigning) the permission to print the information regarding the approved proposal data stored on the master DB 150 to the approver terminal device 300 (or 301).

In the process of the step S409, if it is judged that the column information of the first approval classification is not “1”, the CPU 10 sends an error report to the approver terminal device which has sent the administration number or the like at the step S401 and ends the process (step S411).

According to the second embodiment, by the above mentioned approval processing program, it is arranged that, if the first approval (or the inferior approval) is not performed, the second approval (or the superior approval) cannot be performed. Therefore, the external medium-type electronic approval system according to the second embodiment can reliably administrate the approval information and the approval process even when the approval by the plurality of approvers is needed and when the sequence of a specified approval process is requested.

### 6. Third Embodiment

A third embodiment of the external medium-type electronic approval system of the embodiment shown in FIG. 1 will be explained. The third embodiment is different from the first embodiment in that a memory card, instead of the paper medium, is used for a proposal information registration process and an approval process. Specifically, in the third embodiment, instead of both the “proposal list (in reference to FIG. 12)” outputted through the process of the step S107 of FIG. 10 and the “master update list (in reference to FIG. 15)” outputted through the process of the step S209 of FIG. 13, the same information as the information outputted to the paper medium is stored on the memory card as the embodiment of a “storage medium which is independent of an online network” of the present invention.

The embodiment of the “storage medium which is independent of the online network” of the present invention is not limited to the memory card. For example, a computer readable storage medium such as a CD-ROM, a flexible disk, an IC card, or the like may be adopted. The memory card includes a general card-type memory device, which adopts a flash memory as the storage medium, such as, for example, an SD memory card, a mini SD memory card, a compact flash, a micro drive, a smart medium, a multimedia card, or the like.

6-1. Summary of the Process of Third Embodiment

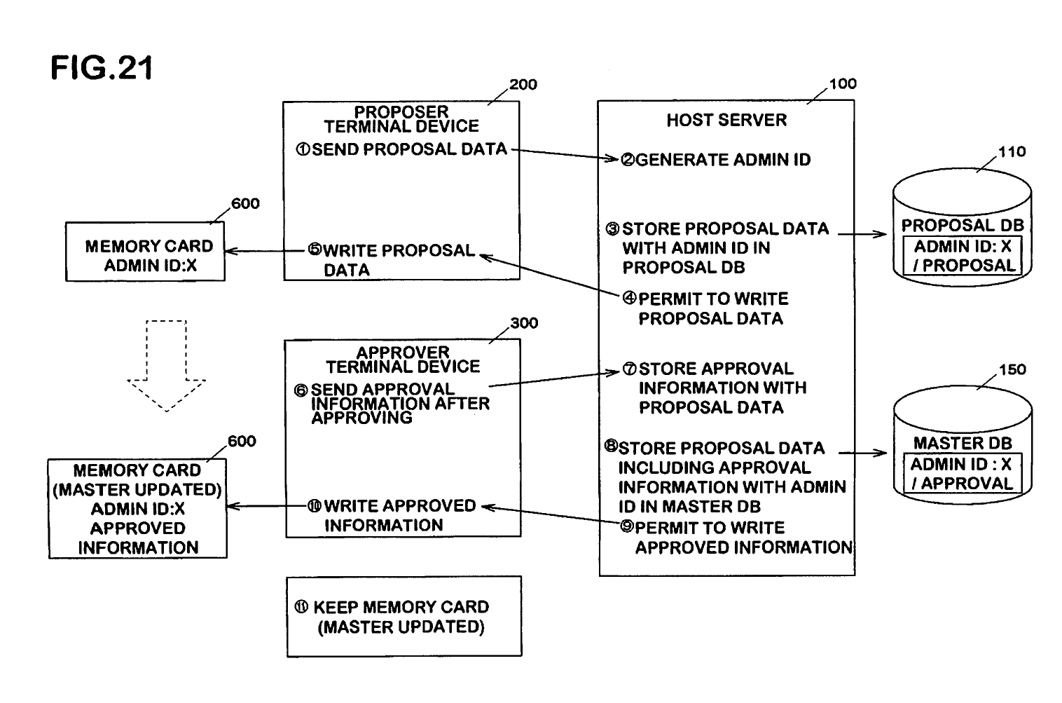

The summary of the process by the third embodiment of the external medium-type electronic approval system will be explained with reference to FIG. 21. Processes of symbols (1) to (3) (which correspond to circled number in FIG. 21.; the same is applied to the following) are the same as those of the same symbols shown in FIG. 2. (4) The host server 100 sends information regarding the permission to write the proposal data on the memory card to the proposer terminal 200. (5) The proposer terminal 200 writes the proposal data on a memory card 600.

The user of the approver terminal 300 receives the memory card 600, on which the proposal data from the user of the proposer terminal 200 is written. The user of the approver terminal 300 reads the stored content of the memory card 600 on the display 33 of the approver terminal 300, for example. (6) When the proposal content is approved, the user of the approver terminal 300 sends the approval information to the host server 100. Processes of symbols (7) and (8) are the same as those of the same symbols shown in FIG. 2. (9) The host server 100 sends the information of the permission to write the approved information regarding the proposal data stored in the master DB 150 on the memory card to the approver terminal 300. (10) The approver terminal 300 writes the approved information on the memory card 600. (11) The user of the approver terminal 300 keeps the memory card 600 at a predetermined location.

Hereinafter, the proposal information registration process and the approval process will be explained by laying emphasis on elements different from the first embodiment.

6-2. Proposal Information Registration Process

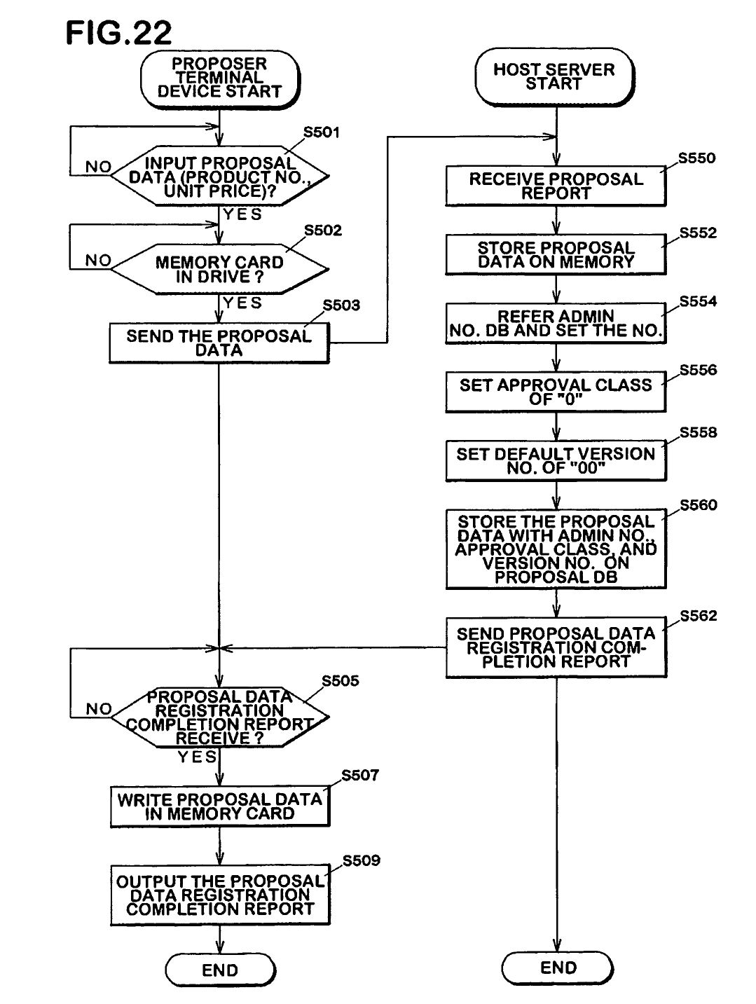

FIG. 22 illustrates a flowchart of the proposal information registration processing program of the third embodiment which is executed by the CPU 20 of the proposer terminal 200 and the CPU 10 of the host server 100.

The CPU 20 of the proposer terminal 200 judges whether or not the proposal data is inputted (step S501 of FIG. 22). FIG. 11A illustrates an example of a screen which is displayed on the display 23 of the proposer terminal 200 at the time of the input of the proposal data. In the step S501, if it is judged that the proposal data is inputted, the CPU 20 judges whether or not the memory card is inserted into the memory card drive 27 (step S502). If it is judged that the memory card is inserted, the CPU 20 sends the inputted proposal data to the host server 100 (step S503).

The CPU 10 of the host server 100 receives the proposal data (step S550) and stores it on the memory 12 (step S552). The CPU 10 sets the administration number with reference to the administration number DB 130 (step S554). The CPU 10 sets the approval classification “0” to the memory 12 (step S556). The CPU 10 sets the default version number “00” to the memory 12 (step S558). The CPU 10 stores the proposal data, which is stored on the memory 12, on the proposal DB 110 by correlating the proposal data with the administration number, the approval classification, and the version number (step S560). The CPU 10 sends the proposal data registration completion report including the information (various pieces of information such as the administration number, the version number, the serial number, the data entry date, the product number, and the unit price) regarding the proposal data stored on the proposal DB 110 to the proposer terminal 200 and ends the process (step S562). The proposal data registration completion report sent by the CPU 10 includes the information which can be used for setting (assigning) the permission to write the registered proposal data to the proposer terminal 200. For example, the setting of the authority for writing may be executed by using a general technique regarding the setting of authority of a user in a computer system.

The CPU 20 judges whether or not the proposal data registration completion report is received (step S505). If it is judged that the proposal data registration completion report is received, the CPU 20 writes the proposal data on the memory card inserted into the memory card drive 27 based on the proposal data registration completion report (step S507). The proposal data written on the memory card is the data similar to the stored content of the proposal DB 110 shown in FIG. 7. The CPU 20 outputs the proposal data registration completion report to the display 23 and ends the process (step S509). FIG. 11B illustrates an example of a screen of the proposal data registration completion report which is displayed on the display 23 of the proposer terminal 200 through the process of the step S509.

6-3. Approval Process

In the external medium-type electronic approval system of the third embodiment, the electronic approval is performed in combination with the memory card. After examining the content of the proposal information (in reference to the step S507 of FIG. 22 and FIG. 12) stored on the memory card by the user (the proposer) of the proposer terminal 200 through the above-described proposal information registration process, the approver decides approval. If the approval is decided, the user of the approver terminal 300 accesses to the host server 100 and performs a process of storing the record that the proposal content of the unit price registration is approved.

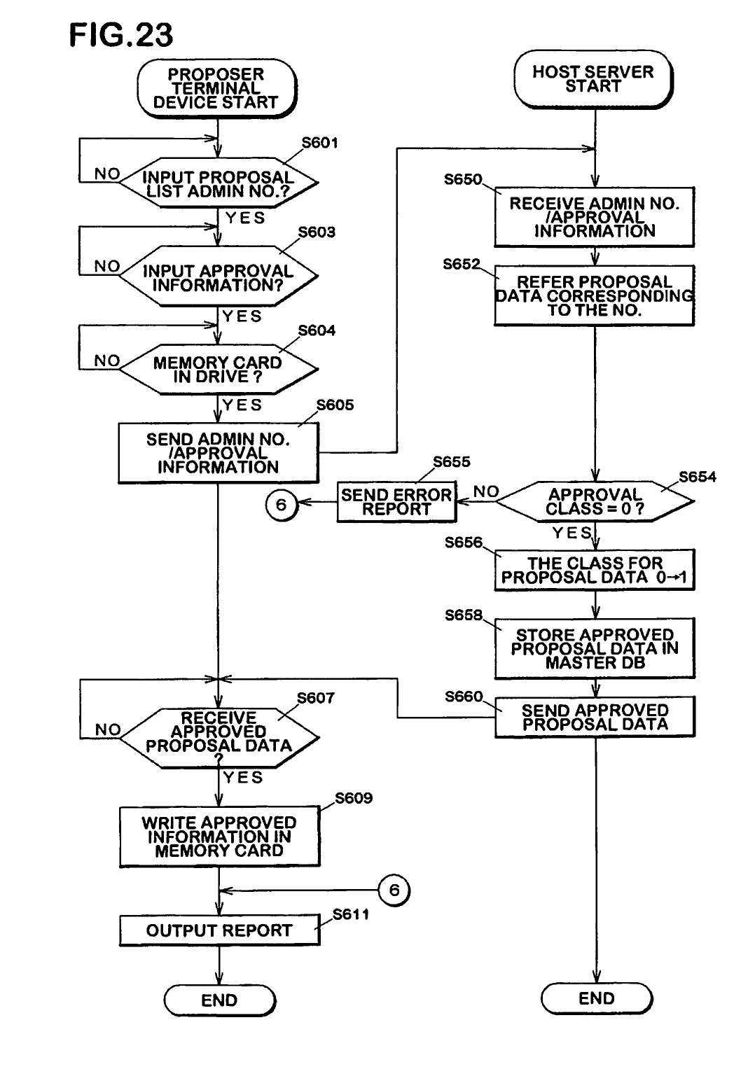

FIG. 23 illustrates a flowchart of the approval processing program of the third embodiment which is executed by the CPU 30 of the approver terminal 300 and the CPU 10 of the host server 100. The CPU 30 of the approver terminal 300 judges whether or not the “administration number” is inputted (step S601 of FIG. 23). If it is judged that the administration number is inputted, the CPU 30 judges whether or not the approval information is inputted (step S603). FIG. 14 illustrates an example of a screen which is displayed on the display 33 of the approver terminal 300 at the time of performing the approval process. If it is judged that the approval information is inputted, the CPU 30 judges whether or not the memory card is inserted into the memory card drive 37 (step S604).

If it is judged that the memory card is inserted, the CPU 30 sends the information of the administration number and the flag information regarding the approval to the host server 100 (step S605).

The CPU 10 of the host server 100 receives the information of the administration number and the flag information regarding the approval (step S650). The CPU 10 searches the proposal DB 110 and references the proposal data corresponding to the received administration number (step S652). The CPU 10 judges whether or not the column of the approval classification of the referenced proposal data is “0” (step S654). In the case where it is not “0”, that is, in the case of “1” indicating that it is already approved, the CPU 10 sends the error report to the approver terminal 300 (step S655). On the other hand, when the column of the approval classification is “0”, the CPU 10 rewrites the information of “0” of the column of the approval classification to “1” (corresponding to “approved”) (step S656).

The CPU 10 stores the proposal data (the approved proposal data), in which the column of the approval classification is substituted with “1” through the step S656, on the master DB 150 (FIG. 8) (step S658). The CPU 10 sends the information (various pieces of information such as the administration number, the version number, the serial number, the data entry date, the product number, and the unit price) regarding the approved proposal data stored on the proposal DB 110 (or the master DB 150) to the approver terminal 300 and ends the process (step S660). The information regarding the approved proposal data sent by the CPU 10 includes the information which can be used for setting the permission to write the approved proposal data stored on the master DB 150 on the memory card to the approver terminal 300.

The CPU 30 judges whether or not the approved proposal data is received (step S607) and, if it is judged that it is received, writes the approved proposal data on the memory card inserted into the memory card drive 37 based on the content of the approved proposal data (step S609). The proposal data written on the memory card is the data similar to the stored content of the master DB 150 shown in FIG. 8.

The CPU 30 outputs the report content to the display 33 and ends the process (step S611). Through the above-described processes, the user of the approver terminal 300 obtains the memory card on which the approved information is stored through the process of the step S609. The memory card stores the fact that the proposal content stored through the above-described proposal information registration process (FIG. 22) is stored on the master DB 150 as the approved proposal data. The approved proposal data stored on the master DB 150 connected to the network of the external medium-type electronic approval system and the approved proposal data stored on the memory card which is kept physically independently of the same network are stored with the same “administration number”. It is preferable to keep the memory card at the predetermined location. Specifically, as exemplified in FIG. 24B, a memory card 703 on which the approved proposal data is stored with the same administration number as that stored on the master DB 150 is kept at a predetermined location 705.

### 7. Effects of Embodiments

The embodiments have a plurality of features as described above, and, as effects of each feature, the following can be included, for example.

The embodiments have a feature that parts of the approval processes which are executed in an online manner on the network system are distributed in an offline manner independently of the same system. Specifically, in the first and second embodiments, at the time of performing approval, after receiving the proposal list from the proposer as the paper medium, the approver accesses to the host server 100 and stores the approval information. In the third embodiment, at the time of performing approval, after receiving the memory card as the storage medium, the approver accesses to the host server 100 and stores the approval information. In this way, the external medium-type electronic approval system of the embodiment has the effect, as a feature, that a predetermined process including the information transmission from the proposer to the approver, the user authentication of the approver, or the like can be distributed in an offline manner. The predetermined process is one of the processes, which are expected to have the largest load experienced in a system construction or administration required for executing the electronic approval process. Therefore, according to the embodiments, it can be expected that the load required for the construction and management of the entire electronic approval system is reduced.

In the first embodiment, all the three of “(1) the proposal list” (FIG. 12) printed through the proposal information registration process (the flowchart of FIG. 10), “(2) the master update list” (FIG. 15) printed through the approval process (the flowchart of FIG. 13), and “(3) the approved proposal data” stored on the master DB 150 through the process of the step S258 of FIG. 13 are unified with the same administration number (tied with the administration number). In this way, by associating the paper document including the content regarding the proposal data with the data including the same content by means of the administration number, the consistency between the actual approved content (the sealed proposal list) by the user (the approver) of the approver terminal 300 and the content of the stored electronic data (the approved proposal data) can be easily confirmed. Further, in the embodiments, the approval contents, by correlating them with each other by means of the administration number, are kept with the two types of mediums, the paper document and the electronic data, and thus, the reliability for keeping the approval content is enhanced. Further, in order to confirm the approval content, any one of the two types of mediums, the paper document and the electronic data, may be referenced. For example, when the user references the paper document (in reference to the proposal list or the master update list), it has an advantage that the user can save the trouble in reading the electronic data of the approved proposal content after accessing to the host server 100 with a terminal device.

In the embodiments, while the proposal list is printed in the proposal information registration process (the step S107 of FIG. 10), the master update list is printed after being stored on the master DB 150 as the approved proposal data in the approval process (in reference to the step S209 in FIG. 13). Therefore, the consistency between the content of the printed proposal list and the actual proposal content (the latest content of the proposal data) can be easily confirmed or the mismatch can be easily found. Specifically, suppose that, even when the proposal data is corrected by means of the proposal information registration process, the approver erroneously seals the proposal list before the correction is made (the old proposal list). In such a case, the content of the old proposal list and the content of the master update list do not match with each other. In addition, when the proposal data is corrected, the version number is increased by 1 (in reference to the step S358 of FIG. 17), and thus the combination of the administration number included in the old proposal list and the version number (the display of the administration number X and the version number N) and the combination of the administration number included in the master update list and the version number (the display of the administration number X and the version number N+1) do not match with each other. Therefore, by comparing the contents of both paper documents (or the version numbers) with each other, the consistency between the actual approval content of the approver and the update content of the electronic data can be easily confirmed. Here, as explained in the embodiments, when the “proposal list (sealed)” and the “master update list” by correlating with each other by means of the same administration number are kept by attaching them with a stapler or paste or the like, it is preferable that the consistency between the approval content of the approver and the update content of the electronic data can be substantially easily confirmed.

In the present embodiments, at the time of storing the proposal data on the proposal DB 110, the CPU 10 of the host server 100 obtains the proposal data, in which the columns for “history” are “0”, among the “administration numbers” stored on the administration number DB 130 shown in FIG. 9, in the ascending order of the administration number. (See the step S154 of FIG. 10.) Therefore, it has an advantage in that an error of assigning the same administration number to different sets of proposal data twice or the like can never be caused.

In the embodiments, the approved proposal data is stored on the master DB 150. Therefore, by performing a general database search etc., the user can easily execute a history search of the approved content etc.

In the embodiments, the approver is to use the approval (seal) for the proposal list (the paper document) and the approval process together. Therefore, in the embodiments, by using a computer, the storage or the like of the approved proposal data on the master DB 150 can be efficiently executed. Further, by using the paper document together, the reliability of approval for the proposal content can be increased. Further, when the entire approval process is implemented with the computer, a special process such as the authentication of the user who operates the approver terminal device 300 or an electronic seal or the like is needed. In the embodiments, however, such processes are supplemented with the paper document, and thus the investment for the system development is extensively suppressed. Moreover, in the embodiments, the configuration in which the special process such as the user authentication or the electronic seal or the like is not performed is exemplified. However, the present invention is not limited to this configuration. For example, in order to assign the permission to approve only to a specified user and in order to perform the user authentication of the approver terminal device 300, general authentication means (including means using a password, a combination of a user ID and a password, or the like) may be adopted.

### 8. Other Embodiments

8-1. Variation of Output Method of Paper Document

In the embodiments, there is disclosed the configuration in which the printing of the proposal form is performed at the proposer terminal device 200 (in reference to the step S107 of FIG. 10) and the printing of the master update list is performed at the approver terminal device 300 (in reference to the step S209 of FIG. 13). However, the present invention is not limited to this configuration. As other embodiments, any one of the proposal list and the master update list or both of the proposal list and the master update list may be printed at the host server 100. Specifically, in the case of the proposal list, for example, after processing the step S162 of FIG. 10, the CPU 10 of the host server 100 prints the proposal list via the printer 18 based on the proposal data stored on the proposal DB 110. (The CPU 10 functions as a proposal form print permission means (or print command means).) Further, in the case of the master update list, for example, after processing the step S260 of FIG. 13, the CPU 10 prints the master update list via the printer 18 based on the approved proposal data stored on the master DB 150. (The CPU 10 functions as an approved proposal form print permission means (or print command means).)

8-2. Embodiments of Device Configuration

Although proposal database 110, administration number database 130, and master database 150 are stored in hard disk 14 of host server 100 in the embodiments, the present invention is not limited thereto. In alternative embodiments, all or a part of these database are stored in hard disk 24 of proposer terminal device 200, hard disk 34 of approver terminal device 300, or the like. In this case, CPU 10 of host server 100 performs the proposal information registration process or approval process by accessing database stored in hard disk of the terminal devices.

8-3. Program Execution

In the embodiments, the computer program for CPU 10, CPU 20, and CPU 30 are stored in hard disk 14, hard disk 24, and hard disk 34, respectively. The computer program can be installed on the hard disk etc. from an installation CD-ROM (not shown). In alternative embodiments, the program can be installed from computer-readable storage media such as DVD-ROM, a flexible disk (FD) or IC card (not shown). Alternatively, the program can be downloaded to the devices via the communications lines. The program can be installed on the devices from the CD-ROM, and the device executes the installed program. In alternative embodiments, the device can directly execute the program stored on the CD-ROM.

Computer-executable programs used in the embodiments include a program to be executable just after installation, a source program, a program that needs to be converted to another format (e.g. compressed data or encrypted program), or a program to be executable within a module.

In the embodiments, each function illustrated in FIG. 3 are accomplished with both CPU and computer program. In other embodiments, all or a part of the functions can be accomplished with hardware logic (e.g. logic circuit) (not shown).

A general description of the present invention as well as preferred embodiments of the invention has been set forth above. It is to be expressly understood, however, the terms described above are for purpose of illustration only and are not intended as definitions of the limits of the invention. Those skilled in the art to which the present invention pertains will recognize and be able to practice other variations in the system, device, and methods described which fall within the teachings of this invention. Accordingly, all such modifications are deemed to be within the scope of the invention.

What is claimed is:

1. A networked computer system comprising:
(a) an online-network which is accessible to multiple users;
(b) a server device connected to the online-network for storing a database comprising proposal data proposed by a first user and needs to be approved by a second user;
(c) a first computer operated by the first user for inputting the proposal data and storing it in the database on the server device through the online-network; and
(d) a second computer operated by the second user for accessing the proposal data on the server device, adding approval information with respect to the proposal data, and storing it in the database on the server device through the online-network;
wherein the computer system further comprising:
(e) a storage medium which is independent of the online-network to be used for writing proposal data on the medium in accordance with the server device direction when the proposal data is stored on the database at the time of inputting the proposal data by the first user, wherein the medium can be transferable from the first user to the second user for approval session subsequent to the proposal data inputting session, and is used for writing approval information on the medium in accordance with the server device direction when the approval information is added in the database at the time of inputting the approval information by the second user, as well as for writing an identification information, which can be used for correlating the proposal data and/or the approval information in the medium with the proposal data and/or the approval data in the database, on the medium.

2. An approval administration system comprising:
(a) means for obtaining proposal data sent from a terminal device operated by a proposer;
(b) means for generating an administration ID which can be used for uniquely identify proposal data in the system when the proposal data obtaining means obtains the proposal data;
(c) means for storing the proposal data on a proposal data storing unit in correlating the proposal data with the administration ID;
(d) means for outputting permission to print a proposal form with the administration ID based on the proposal data stored by the proposal data storing means;
(e) means for obtaining approval information sent from a terminal device operated by an approver who approves the proposal form;
(f) means for adding approval information to the proposal data when the approval information obtaining means obtains the approval information;
(g) means for storing proposal data, which is stored by the proposal data storing means, on an approved proposal data storing unit only if the adding means adds approval information to the stored proposal data; and
(h) means for outputting permission to print an approved proposal form with the administration ID based on the approved proposal data only when the approved proposal data storing means stores the proposal data.

3. An approval administration system comprising:
(a) means for obtaining proposal data sent from a terminal device operated by a proposer;
(b) means for generating an administration ID which can be used for uniquely identify proposal data in the system when the proposal data obtaining means obtains the proposal data;
(c) means for storing the proposal data on a proposal data storing unit in correlating the proposal data with the administration ID;
(d) means for outputting permission to store proposal information with the administration ID on a storage medium which is independently transportable from the online-network based on the proposal data stored by the proposal data storing means;
(e) means for obtaining approval information sent from a terminal device operated by an approver who approves the proposal information;
(f) means for adding approval information to the proposal data when the approval information obtaining means obtains the approval information;
(g) means for storing proposal data, which is stored by the proposal data storing means, on an approved proposal data storing unit only if the adding means adds approval information to the stored proposal data; and
(h) means for outputting permission to store approved proposal information with the administration ID on the medium based on the approved proposal data only when the approved proposal data storing means stores the proposal data.

4. An approval administration system for administrating approval information, a central processing unit (CPU) of the approval administration system is to execute the procedures of:
(a) obtaining proposal data sent from a terminal device operated by a proposer;
(b) generating an administration ID which can be used for uniquely identify proposal data in the system when obtaining the proposal data;
(c) storing the proposal data on a proposal data storing unit in correlating the proposal data with the administration ID;
(d) outputting permission to print a proposal form with the administration ID based on the stored proposal data;
(e) obtaining approval information sent from a terminal device operated by an approver who approves the proposal form;
(f) adding approval information to the proposal data when obtaining the approval information;
(g) storing proposal data, which is stored on the proposal data storing unit, on an approved proposal data storing unit only if approval information is added to the stored proposal data; and
(h) outputting permission to print an approved proposal form with the administration ID based on the approved proposal data only when storing the approved proposal data.

5. A computer readable program for an approval administration device, wherein the program is implemented in a computer and capable of causing the computer to perform:
(a) means for obtaining proposal data sent from a terminal device operated by a proposer;
(b) means for generating an administration ID which can be used for uniquely identify proposal data in the system when the proposal data obtaining means obtains the proposal data;
(c) means for storing the proposal data on a proposal data storing unit in correlating the proposal data with the administration ID;
(d) means for outputting permission to print a proposal form with the administration ID based on the proposal data stored by the proposal data storing means;
(e) means for obtaining approval information sent from a terminal device operated by an approver who approves the proposal form;
(f) means for adding approval information to the proposal data when the approval information obtaining means obtains the approval information;
(g) means for storing proposal data, which is stored by the proposal data storing means, on an approved proposal data storing unit only if the adding means adds approval information to the stored proposal data; and
(h) means for outputting permission to print an approved proposal form with the administration ID based on the approved proposal data only when the approved proposal data storing means stores the proposal data.

6. The approval administration system according to claim 2, wherein the proposal form and the approved proposal form are attachable to each other.

7. The approval administration system according to claim 2, wherein (b) the ID generating means further generates a new administration ID, which is distinct from the administration ID, with respect to the proposal data stored by the proposal data storing means when obtaining a correction request and corrected proposal data sent from the proposer terminal device;
(c) the proposal data storing means stores the corrected proposal data on the proposal data storing unit in correlating the corrected proposal data with the new administration ID; and
(d) the print permission outputting means outputs permission to print a proposal form with the new administration ID based on the proposal data stored by (c) the proposal data storing means.

8. An approval administration method utilizing a computer system comprising:
(a) proposal data obtaining means obtains proposal data sent from a terminal device operated by a proposer;
(b) administration ID generating means generates an administration ID which can be used for uniquely identify proposal data in the system when the proposal data obtaining means obtains the proposal data;
(c) proposal data storing means stores the proposal data on a proposal data storing unit in correlating the proposal data with the administration ID;
(d) proposal form print permission outputting means outputs permission to print a proposal form with the administration ID based on the proposal data stored by the proposal data storing means;
(e) approval information obtaining means obtains approval information sent from a terminal device operated by an approver who approves the proposal form;
(f) approval information adding means adds approval information to the proposal data when the approval information obtaining means obtains the approval information;
(g) approved proposal data storing means stores proposal data, which is stored by the proposal data storing means, on an approved proposal data storing unit only if the adding means adds approval information to the stored proposal data; and
(h) approved proposal form print permission means outputs permission to print an approved proposal form with the administration ID based on the approved proposal data only when the approved proposal data storing means stores the proposal data.

9. An approval administration method utilizing a computer system comprising:
(a) generating an administration ID which can be used for uniquely identify proposal data in the system when obtaining the proposal data sent from a terminal device operated by a proposer;
(b) storing the proposal data on a proposal data storing unit in correlating the proposal data with the administration ID;
(c) outputting permission to print a proposal form with the administration ID based on the stored proposal data;
(d) adding approval information to the proposal data when obtaining the approval information sent from a terminal device operated by an approver who approves the proposal form; and
(e) outputting permission to print an approved proposal form with the administration ID based on the approved proposal data only when adding approval information to the stored proposal data and storing proposal data, which is stored on the proposal data storing unit, on an approved proposal data storing unit.
